(19) United States
(12) Patent Application Publication
(10) Pub. No.: US 2011/0258145 A1
(43) Pub. Date: Oct. 20, 2011

(54) METHOD OF MANUFACTURING ARTICLES

(76) Inventor: Mary Kaye Denning, Lakewood, OH (US)

(21) Appl. No.: 13/035,642

(22) Filed: Feb. 25, 2011

Related U.S. Application Data
(60) Provisional application No. 61/324,755, filed on Apr. 16, 2010.

(51) Int. Cl. G06Q 90/00

(52) U.S. Cl. 705/500

(57) ABSTRACT

A manufacility (200) comprising a gallery (210), a concierge (220), a networking lounge (230), a training center (240), a media room (250), manucap administration (260), customer service (270), surrogate sectors (280), and job shop advocates (290). The manufacility (200) can facilitate methods for manufacturing articles, such as a method wherein a core-competency inventory is consulted to appoint job shops, a method wherein a raw idea is transformed into an article, and/or a method wherein an idea is converted from sketch to shelf and packaged in an innovation kit.

### RELATED APPLICATIONS

This application is related to U.S. Provisional Patent Application No. 61/307,843 filed on Feb. 25, 2010 and U.S. Provisional Patent Application No. 61/324,755 filed on Apr. 16, 2010. The entire disclosures of these earlier applications are hereby incorporated by reference. To the extent that inconsistencies exist between the present application and any incorporated application(s), the present application governs interpretation to the extent necessary to avoid indefiniteness and/or clarity issues.

### BACKGROUND

To say that the American manufacturing industry is in trouble would be an understatement. Historical manufacturing practices, that served us well in years gone by, are no longer effective. And these practices are unlikely to work again any time in the foreseeable future.

### SUMMARY

A manufacturing-facilitating nucleus (“manufacility”) and manufacturing methods are provided to revolutionize and revive the American manufacturing industry. This facility and these methods encourage inventors to be inventors (and profitable), entrepreneurs to be entrepreneurs (and successful), job shops to manufacture component parts (and prosper), and industrial regions to economically recover (and thrive).

### DRAWINGS

FIGS. 1A-1F show various stages of the manufacturing process.

FIG. 2 shows a manufacility 200.

FIGS. 3A-3Q show a method 300 for manufacturing articles wherein an internal core-competency inventory is consulted to appoint production runs.

FIGS. 4A-4E show a method 400 for manufacturing articles wherein a raw idea is transformed into an article.

FIGS. 5A-5G show a method 500 for manufacturing articles wherein an idea is converted from sketch to shelf and packaged in an innovation kit.

### DESCRIPTION

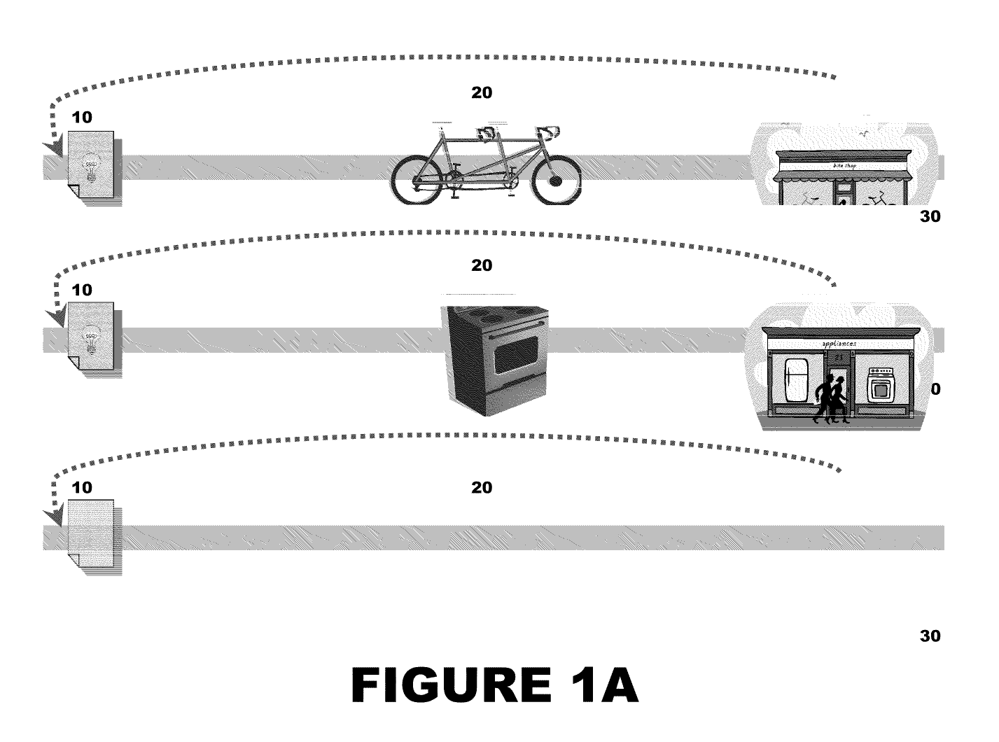

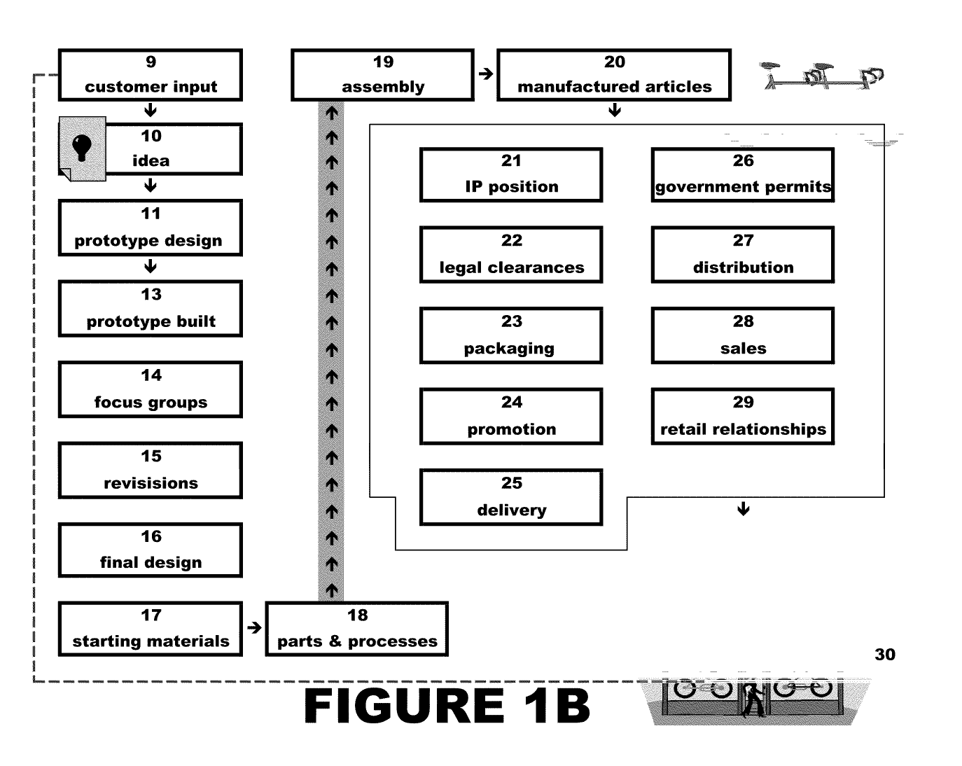

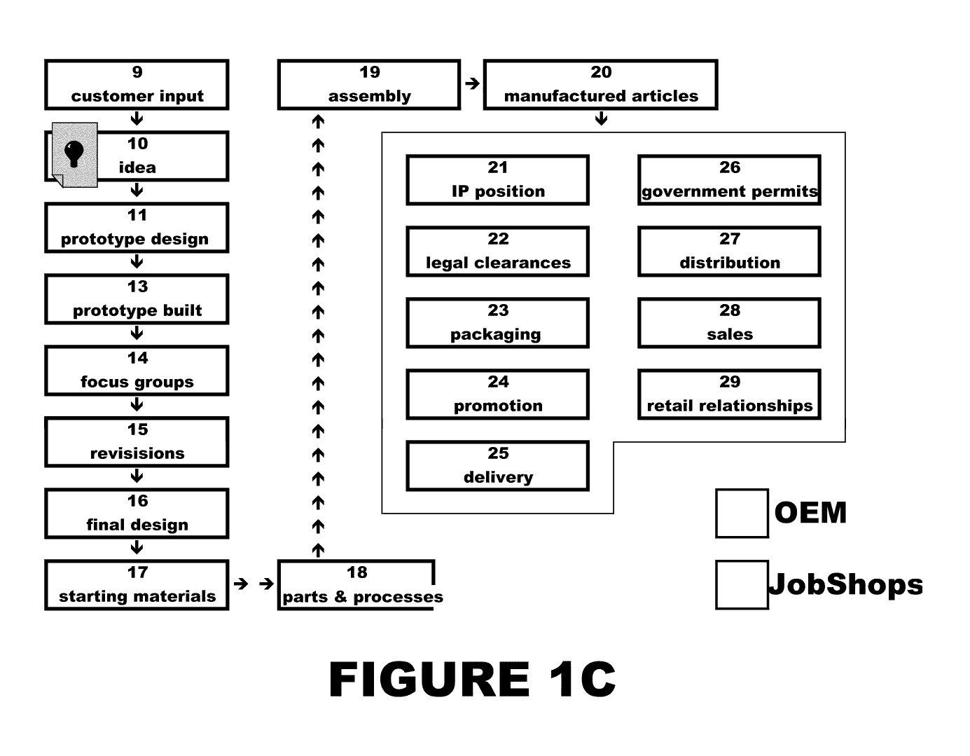

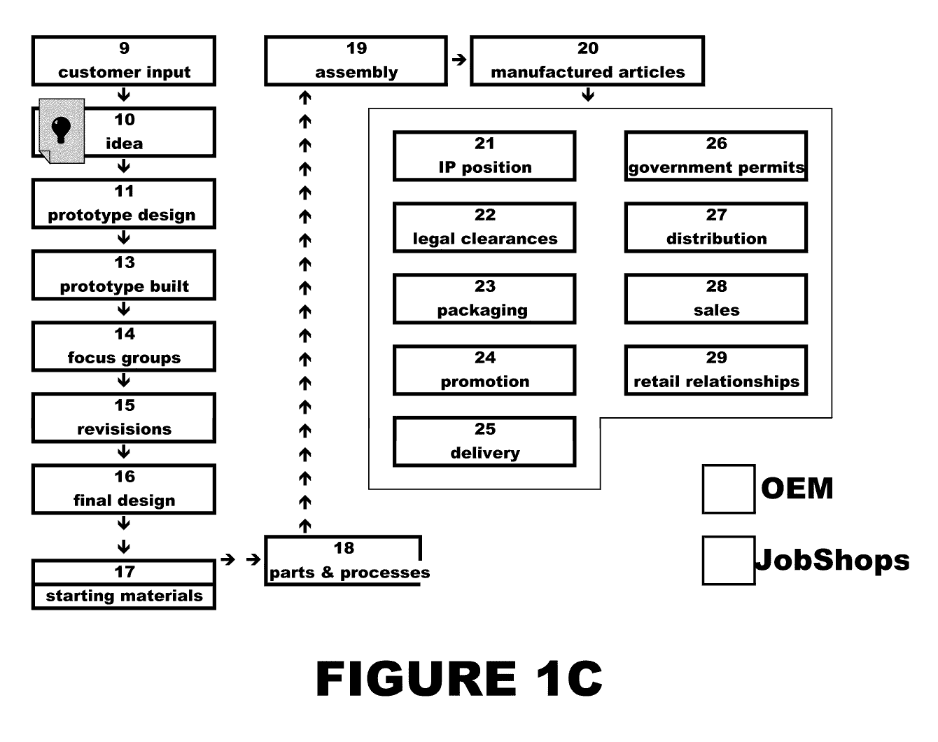

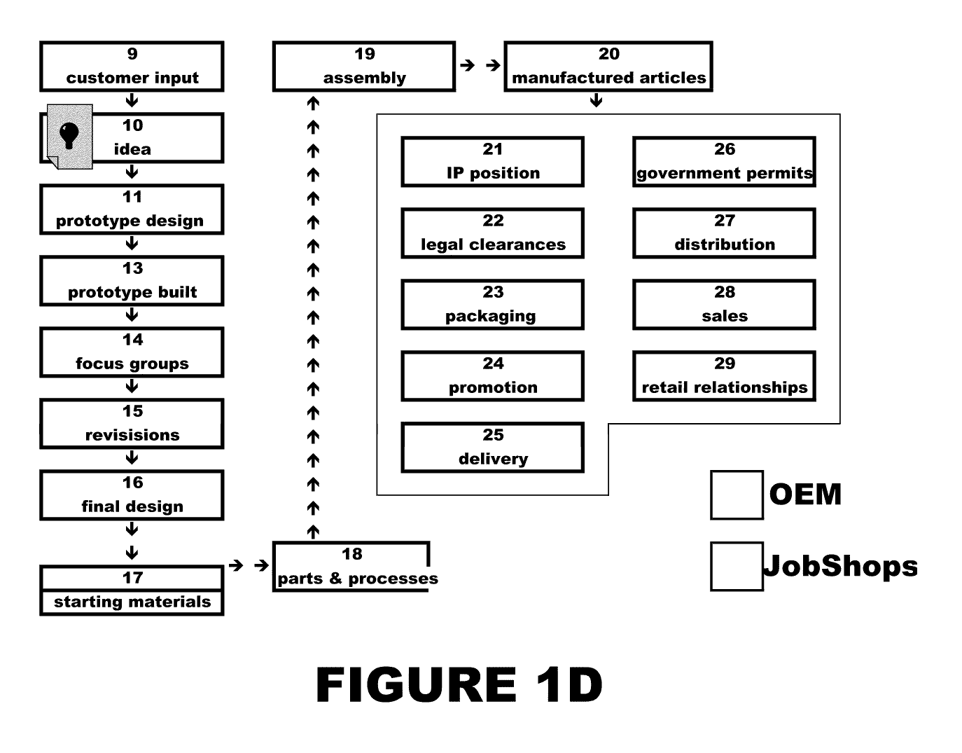

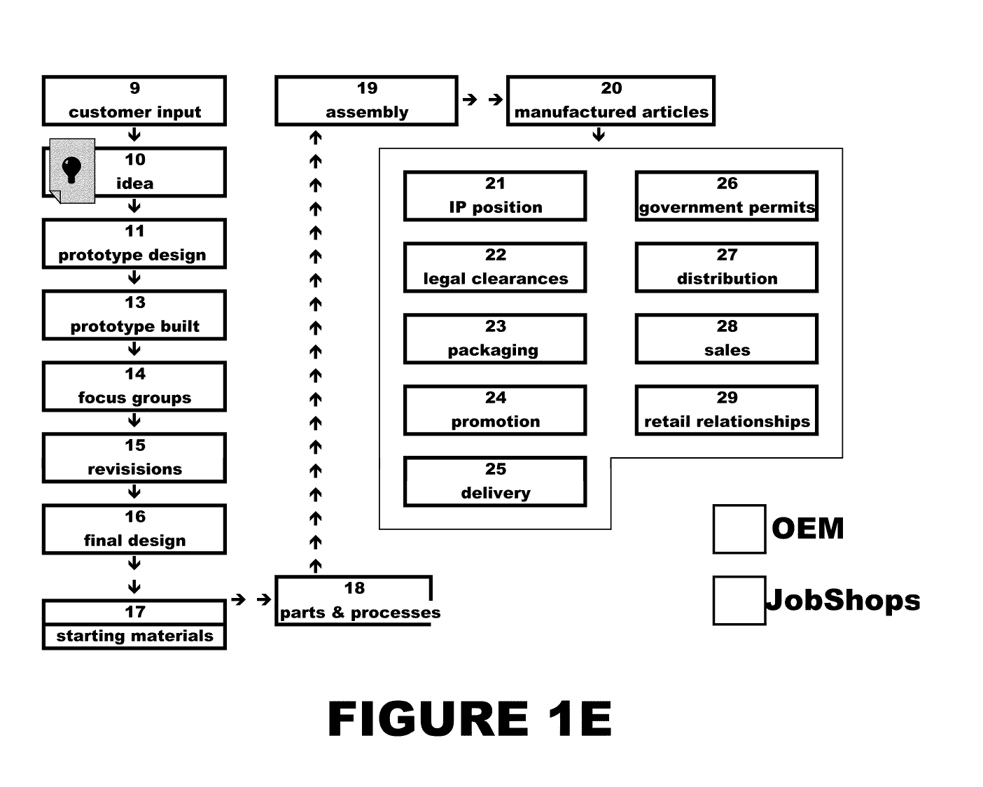

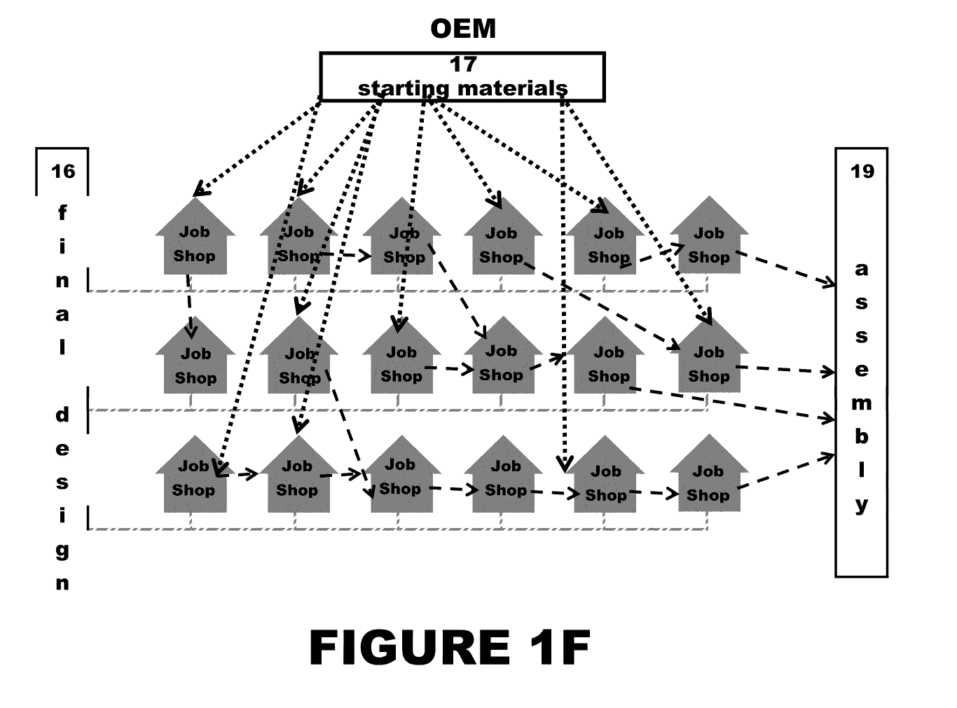

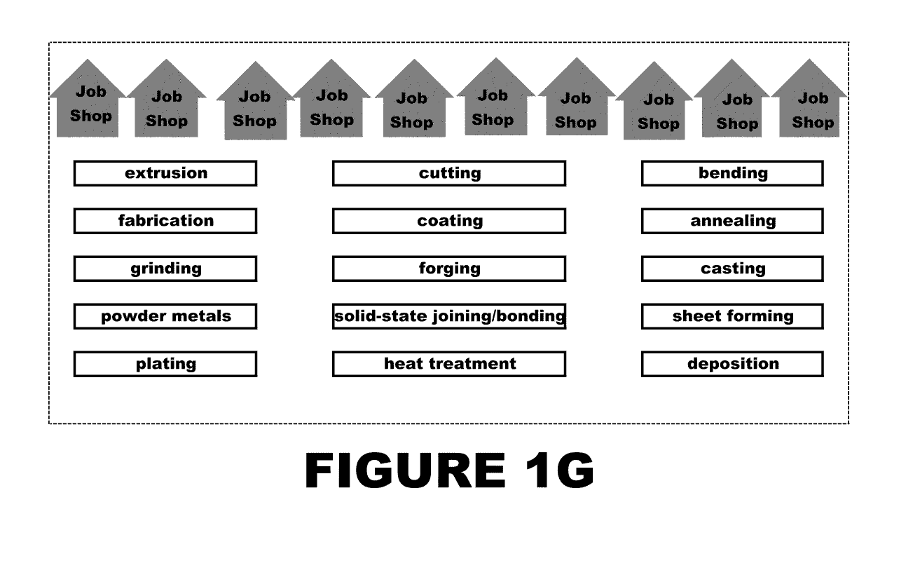

Referring now to the drawings, and initially to FIG. 1A, a traditional sketch-to-shelf conversion timeline is shown. This timeline can generally be described as starting with an idea 10 (e.g., a “sketch”) which is turned into a manufacturable article 20 (e.g., a bicycle in the illustrated embodiment). The manufactured article 20 hopefully then arrives at its final destination 30 (e.g., a “shelf”) for sale to a purchaser. The destination 30 can be for example, a store for consumer products, a distributor for industrial products, or an ecommerce setting.

While the timeline is often not straight, it is linear-terminating at the final destination 30. Customer input does not permeate the sketch-to-shelf conversion process.

As is shown in FIG. 1B, the initial idea 10 is typically developed by a dedicated research and development staff. The researched-and-developed idea 10 is next adapted into a prototype design 11, prototype-building materials are acquired, and a prototype 13 is built. Sometimes a single prototype 13 is made; sometimes multiple prototypes 13 are made. But in either or any event, the number of prototypes 13 made is an extremely small percentage (e.g., 2% or less) of the expected production volume.

The prototype 13 is then subjected to focus groups 14 (or equivalent) to determine its marketability. Based on conclusions reached during the surveying step 14, specifications are revised and revisions 15 are incorporated into the final engineered design 16. Starting materials 17 are sourced. Component parts 18 are made and assembled (step 19) to produce the manufactured articles 20. Before, during, and/or after this manufacturing stage, marketing steps (e.g., IP position 21, legal clearances 22, packaging 23, promotion 24, delivery 25, government permits 26, distribution 27, sales 28, retail relationships 29, etc.) are being undertaken. Through these marketing efforts, the manufactured articles 20 reach the shelf 30, shortly after the assembly step 19.

An “original equipment manufacturer” (OEM) refers to a manufacturing or marketing company that develops, manufactures, markets, and sells end products to purchasers (e.g., individual consumers, industrial companies, institutions, governments, etc.). The role historically played by an OEM in the sketch-to-shelf conversion is shown in FIGS. 1C-1E. The OEM orchestrates and dominates the conversion process.

The only step that is consistently not performed by the OEM is the production of parts and pieces (components) 18. In years gone by, the parts production step 18 was typically accomplished by job shops in service to OEMs (e.g., generally located in the same geographic region as the OEM). In some situations, the job shops were responsible for starting materials 17 and/or assembly 19, but in all cases these tasks were performed for benefit of the OEM.

As shown in FIG. 1F, the OEM provided each of the contracted job shops with relevant production drawings 16 and starting materials 17. Each job shop then performed its contracted services and delivered its component onto either the job shop next in the chain or to the OEM assembly site 19. The job shops operate with a blue-print-specific view, often without knowledge of the ultimate end product.

Job shops were created as exclusive OEM manufacturing-service companies whereby their plants neighbored the master OEM, or at least were near the OEM assembly site 19. But then (at some time in history that is difficult to pinpoint) OEMs began shifting parts-production work away from local job shops. This trend has continued, and, by many accounts (be they accurate or not), has accelerated. The bottom line is that more and more American OEM products are made overseas (e.g., China, India, etc.), despite the public outcry for domestic products.

Local job shops are still occasionally asked to assist with the production of parts for OEM prototypes. But prototype work can be sporadically spaced, very low volume, and known for poor profit margins. While in the early days, prototype assistance by a job shop set the table for real production work, this gentlemen's agreement is no longer honored.

Most existing job shops were borne for the exclusive purpose of providing OEM-dedicated components 18. As shown in FIG. 1G, these shops were built specifically to specialize and supply certain (and often custom) manufacturing capabilities. With this lot in life, the job shops did not need (so they seldom have) a design engineering department, starting-material-sourcing expertise, sophisticated financial experience, a marketing program, and/or a sales force.

Most job shops are relatively small operations, grossing less than $10M per year. Even when they do dabble in engineering design, procurement, sales and/or marketing, it is multi-tasking exercise done with one hand in the machine. And such dabbling generally results in distancing and/or distracting a job shop from its more profitable skills.

That being said, local job shops have the equipment, experience, and enthusiasm to manufacture parts 18 in an extremely economic and effective manner. And in certain geographic regions (such as Northeast Ohio), job shops, when clustered together, can collectively cover the entire gamut of parts-and-pieces production proficiency.

### Manufacility 200

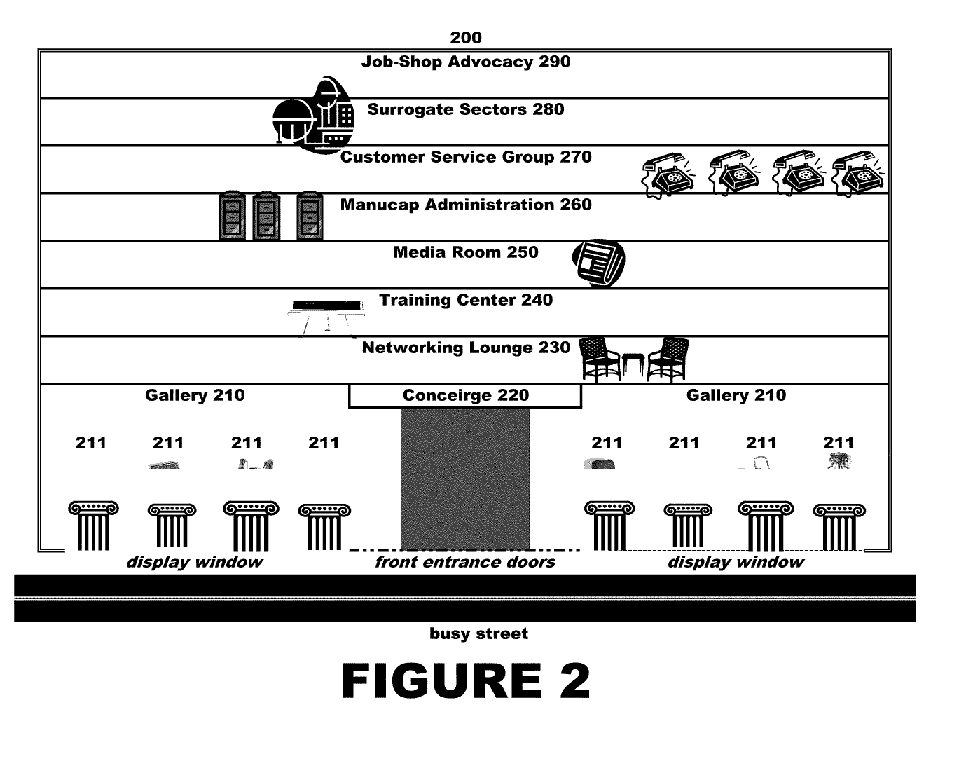

A manufacility 200 is shown in FIG. 2. This facility 200 is a physical building that can be considered the innovation center, or “industrial town square” of a manufacturing region. The manufacility 200 is preferably located on a busy street, with heavy foot traffic, and has a windowed storefront. The location should be chosen so that out-of-towners are encouraged to drop in for visit, much as they would other tourist attractions, such as a Stock Exchange, an Inventors' Hall of Frame, or an Art Museum.

The manufacility 200 can comprise a gallery 210, a concierge 220, a networking lounge 230, a training center 240, a media room 250, a manucap administration 260, customer service 270, surrogate sectors 280, and job shop support 290.

The gallery 210 can occupy the front portion of the manufacility 200 so as to be visible through full-length windows. It preferably has a museum-like quality where tourists would visit, students would field trip, and people would go to just generally awe. The gallery 210 could have, for example, pedestals 211 or other showcases for exhibited items. The items would be constantly changing, making periodic visits to the manufacility 200 a must. A gift shop, archives, a theater, and/or live music could also be provided.

The concierge 220 can be a short walk from the front entrance, much like at a fancy hotel. The concierge 220 can furnish information and/or directions to guests, receive orders from customers, accept quote requests from clients, and/or obtain ideas from inventive entities. The concierge 220 can also coordinate tours of the manufacility 200 and/or provide passes to special events in, for example, the gallery 210.

The networking lounge 230 can be a meeting place whereat members of the manufacturing community gather, much like the penny universities in early England. The lounge 230 can include a coffee shop and comfortable seating to create a casual drop-in-when-you-can atmosphere. Trade journals and newspapers can be scattered on the tables for perusal, news programs can play on wall-mounted television screens, and ticker tape can parade current manucap conditions. The climate can be such that people look forward to stopping by a couple of times a week to run into someone they know (or should know). Easily accessible parking is preferably provided for lounge patrons, to further encourage attendance.

The training center 240 can be considered a common classroom for job shops and other members of the manufacturing community. It can feature a smart board, a speaker podium, video conferencing, global webcasting, and hands-on computer training equipment. The furniture and/or wall dividers can be flexible enough to accommodate both a large audience and smaller break-out sessions. The center 240 provides a forum for members of the manufacturing community to receive updates on environmental, governmental, political, and industrial developments.

The media room 250 is where press releases and other outgoing marketing communications are distributed to different groups of potential clients across all-media. It can also provide a place for constant updates on global conditions, and the headquarters whereat teams of internet-savvy marketers engage the power of crowd sourcing through social media outlets. Live broadcasts can also be transmitted from this room, along with public-relation architecture for individual inventors, new Americans, government agencies, OEMs, job shops, and/or academia.

The manucap administration 260 can serve as the headquarters for the method 300 discussed below. This administration 260 includes an audit team, an update squad, a trading floor, an inventory consultant, a quoting/contracting department, a job-shop appointer, a billing/accounting branch, an inspection squad and/or a transportation dispatcher. As is explained in more detail below, the administration 260 operates as a match-maker for the job shops.

The customer service group 270 can be coordinated to field incoming inquiries from purchasers. This group can assist in serial number tracing, warranty registration, installation instructions, repairs/replacements, dealership directions, and/or product updates. The manufacility 200 preferably has a culture that encourages feedback and the customer service group 270 can coordinate the collection of comments.

The surrogate sectors 280 include OEM-like departments that the jobs shops typically do not have in-house. These departments can include, for example, IP analysis, engineering design, financial guidance, starting-material sourcing and procurement, legal consulting, governmental permitting, certificating, and/or advertising/marketing. These sectors 280 make it possible for the manufacility 200 to step in and play the role of an OEM for otherwise uncoordinated innovation and thereby creating work for the job shops.

The job-shop advocacy 290 dispatches specialized personnel who cater to the job shops, through a shared-services platform, at affordable a la carte prices. These services can include, for example, government contracting, web maintenance, accounting, human resources, import/export paperwork, office supplies, secretarial, business coaching, and/or guidance counseling. In this manner, the manufacility 200 allows each job shop to operate with the same management system as a world-class enterprise.

Thus, the manufacility 200 serves not only as a hub for pre-existing job shops, but also an active marketplace whereat people go to gather, browse, showcase, shop, buy, sell, trade, or otherwise propel ideas into the stream of commerce. And the manufacility 200 can operate in concert with methods (namely methods 300, 400, and 500, introduced below), to encourage inventors to be inventors (and profitable), entrepreneurs to be entrepreneurs (and successful), job shops to manufacture component parts (and prosper), and industrial regions to economically recover (and thrive).

### Method 300

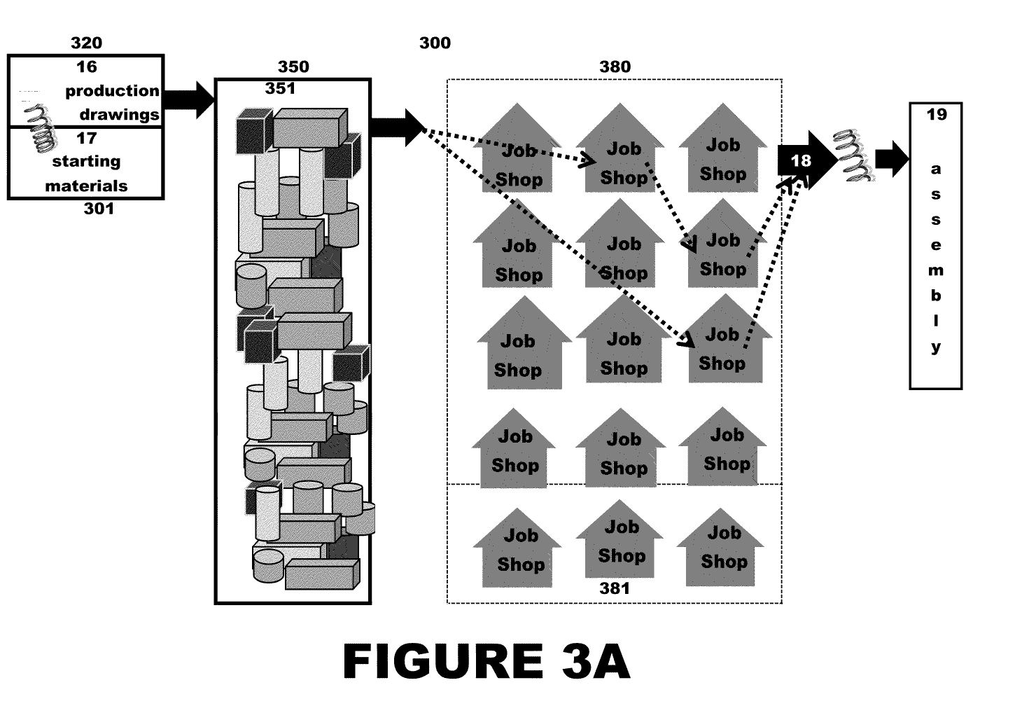

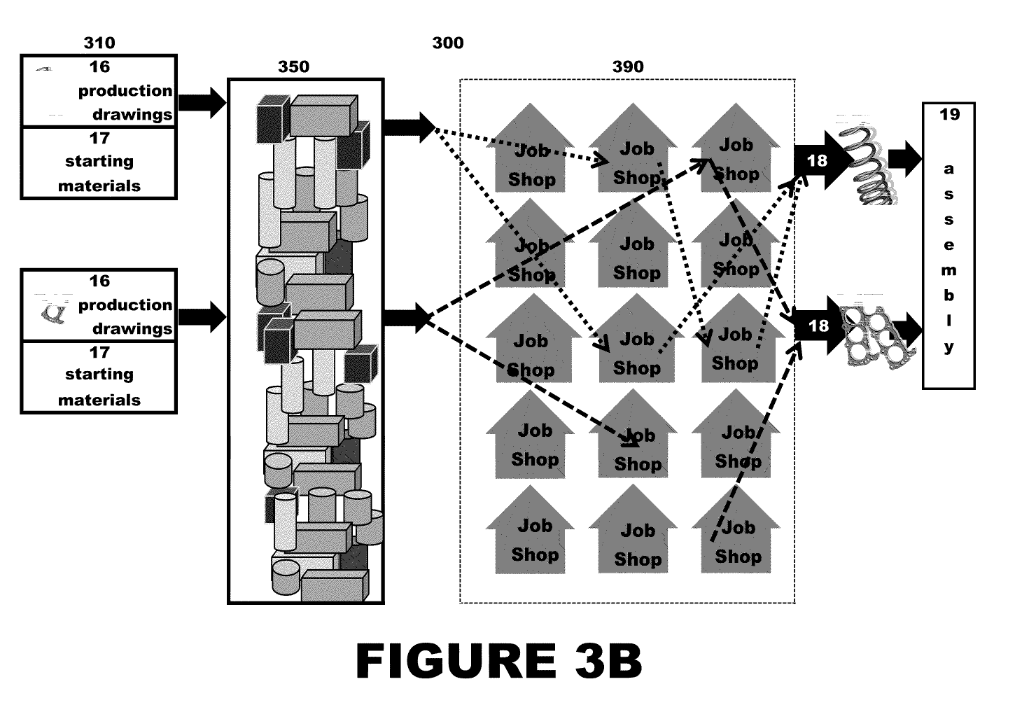

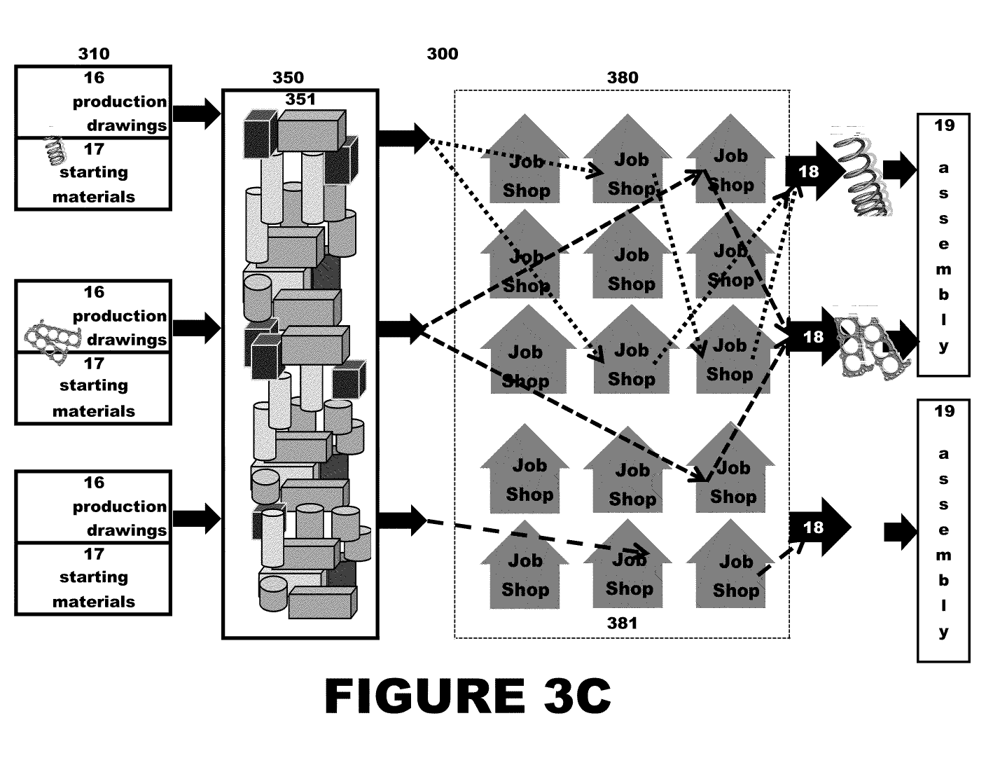

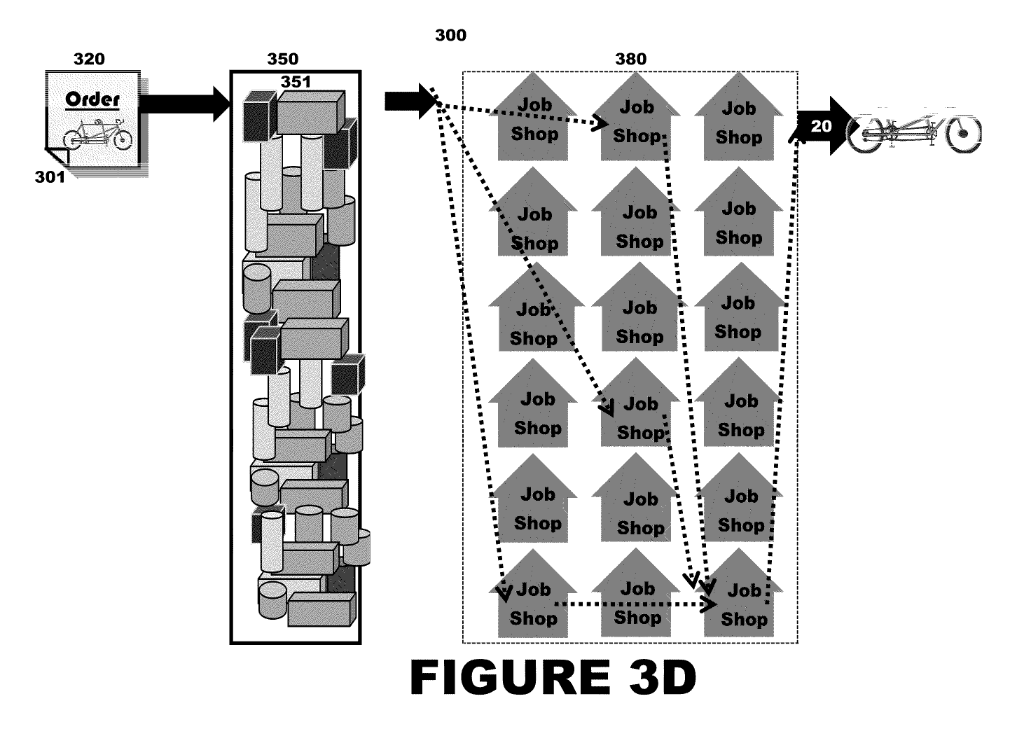

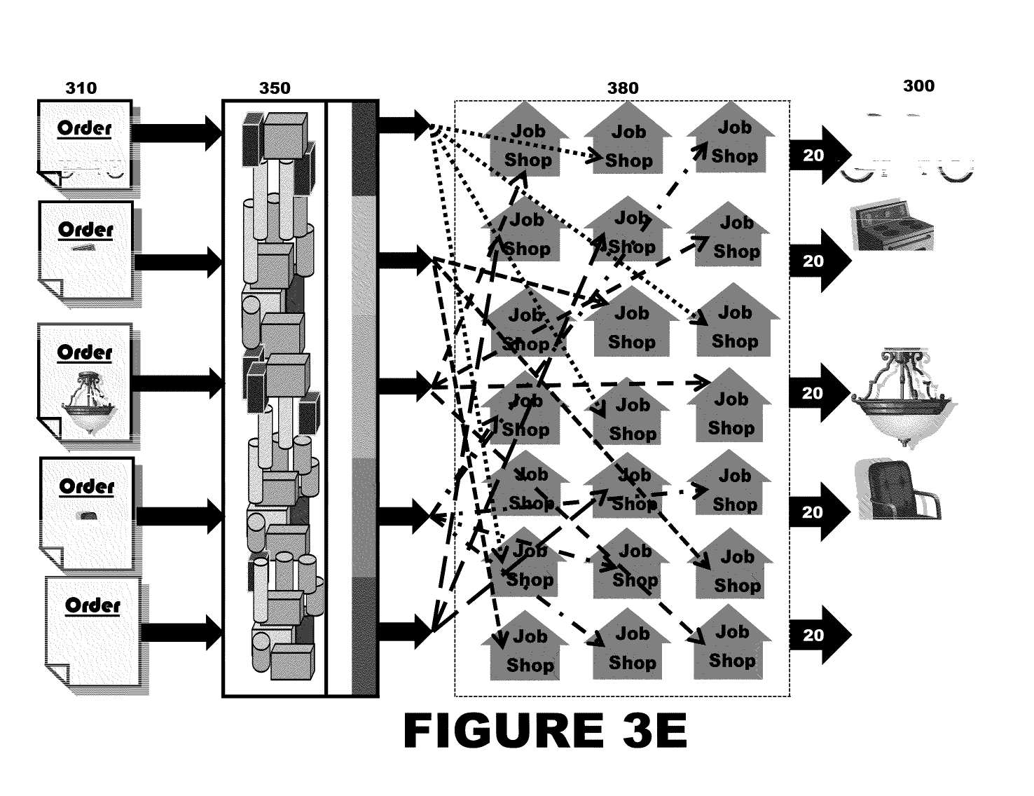

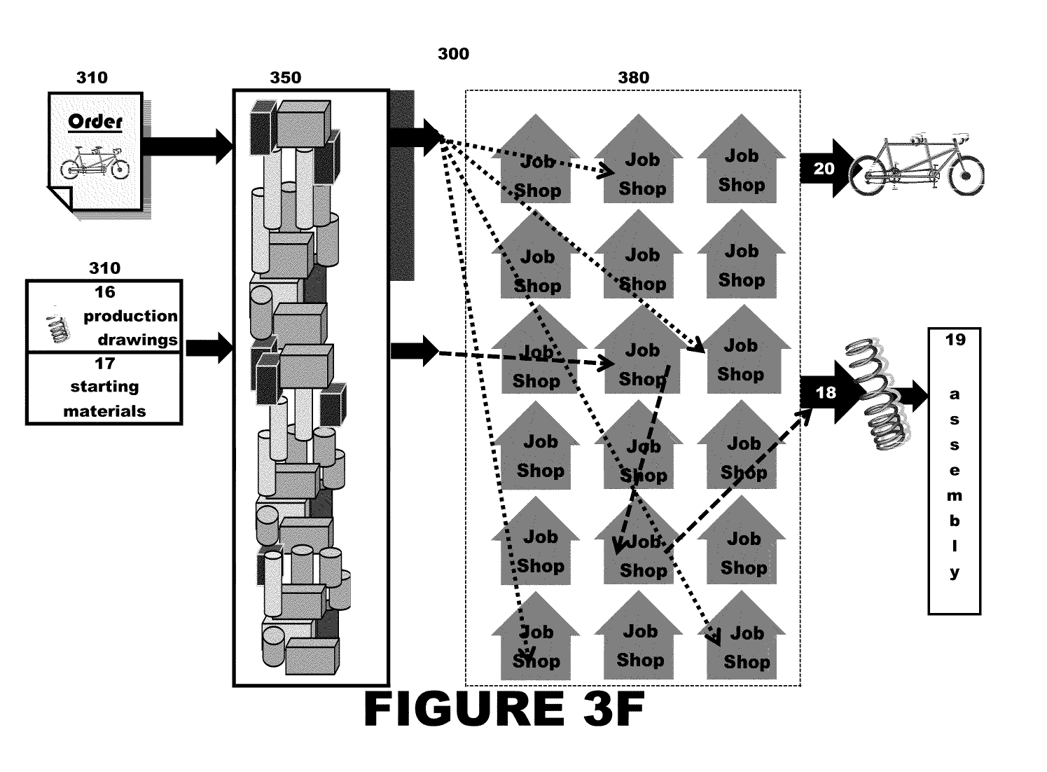

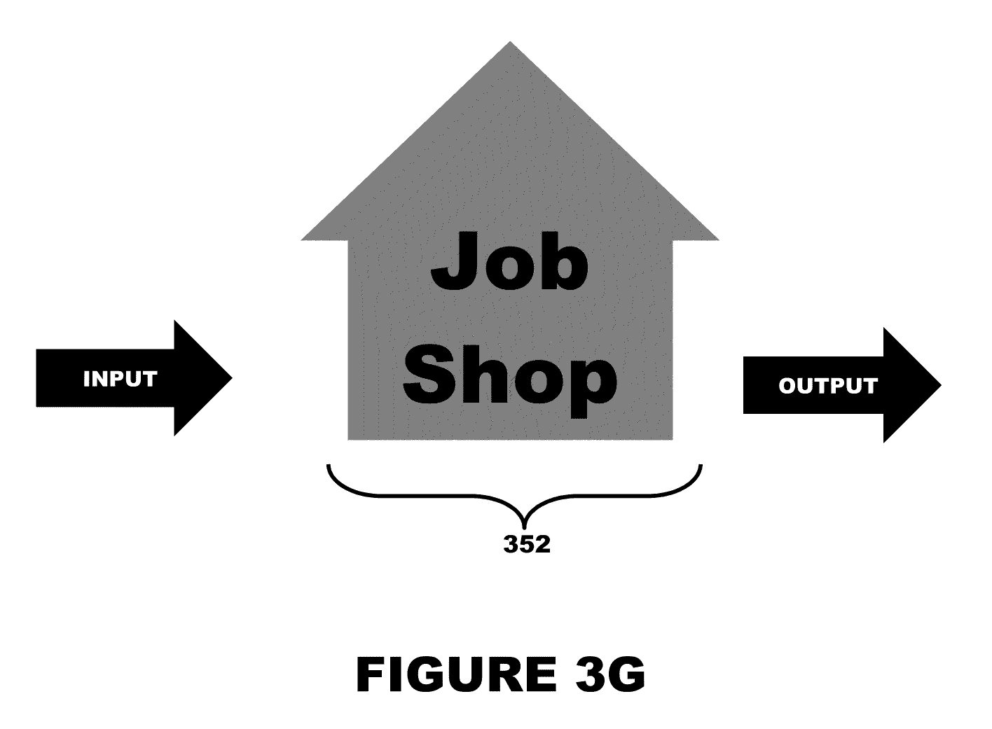

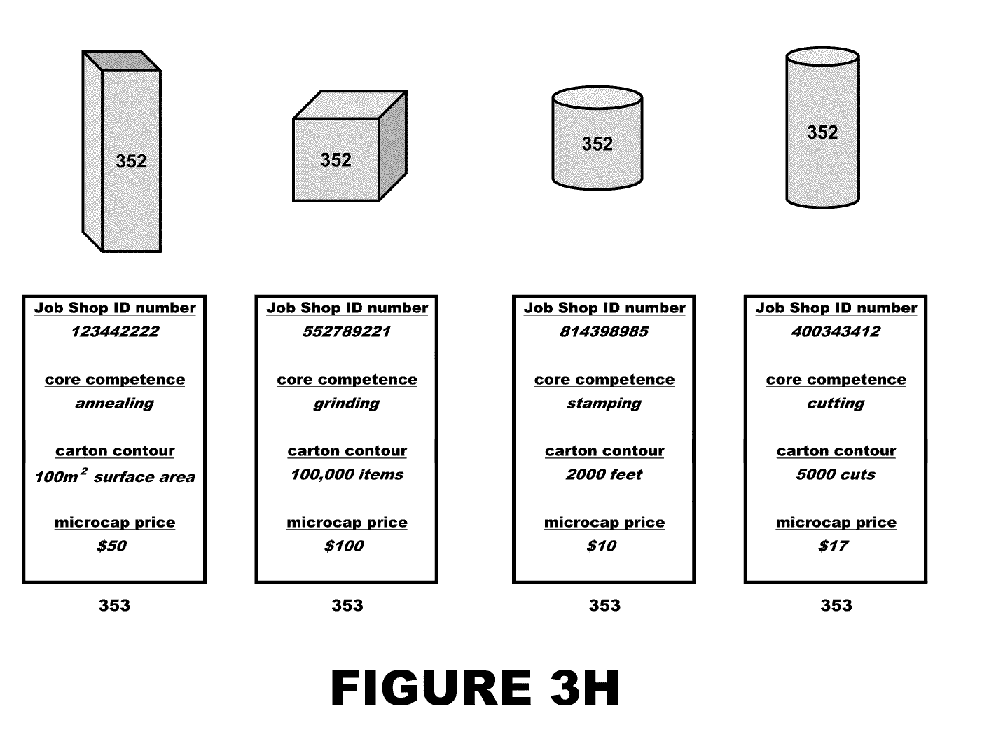

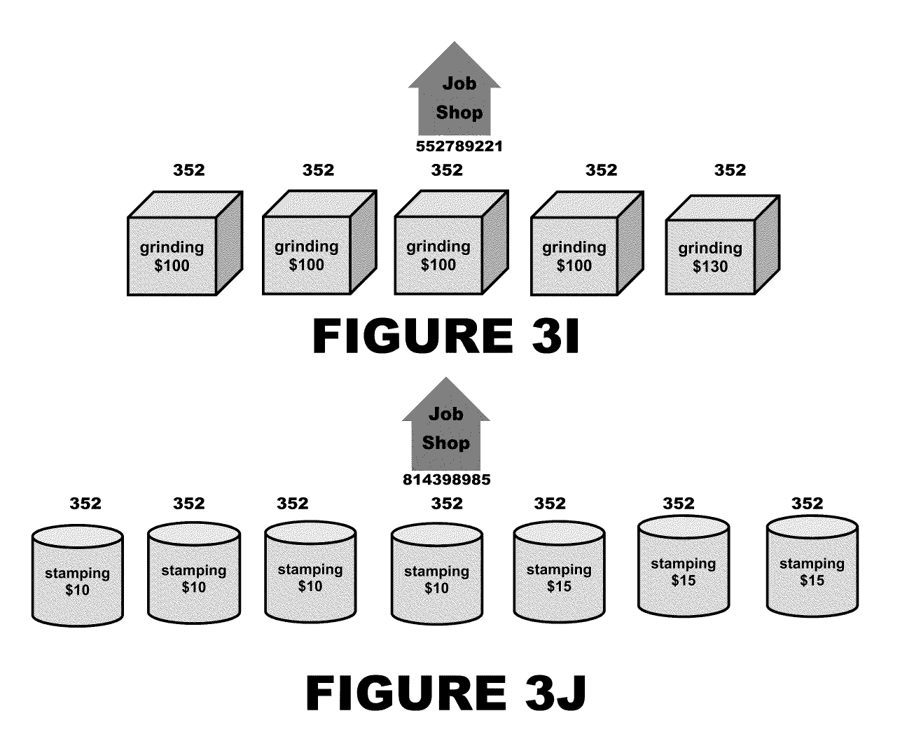

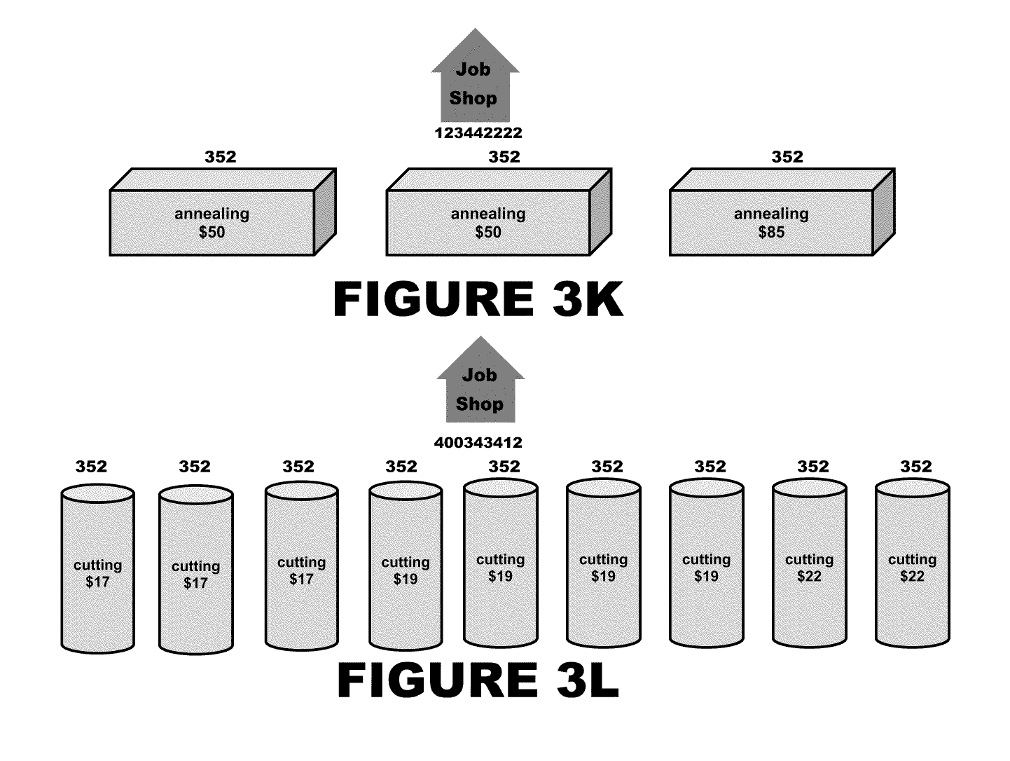

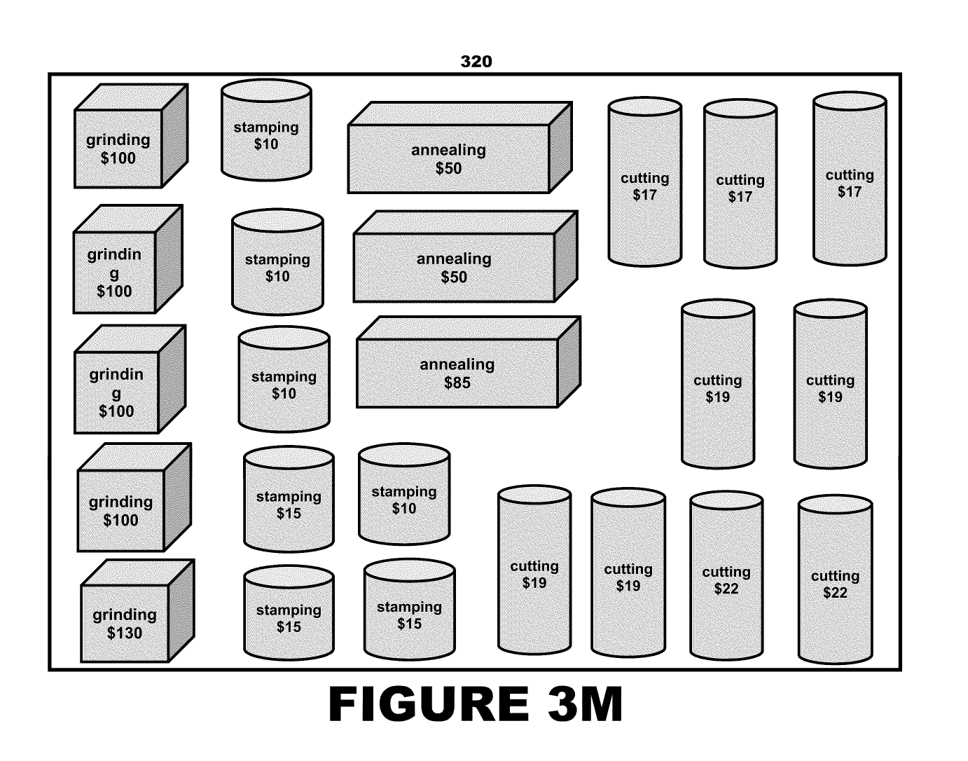

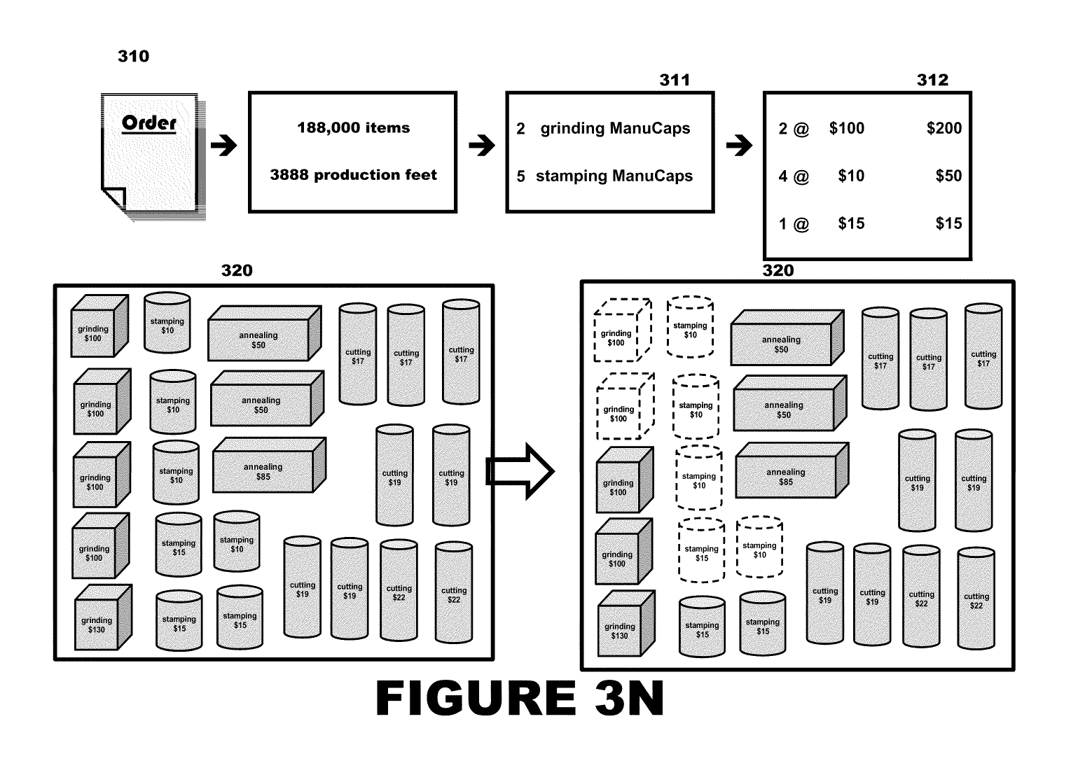

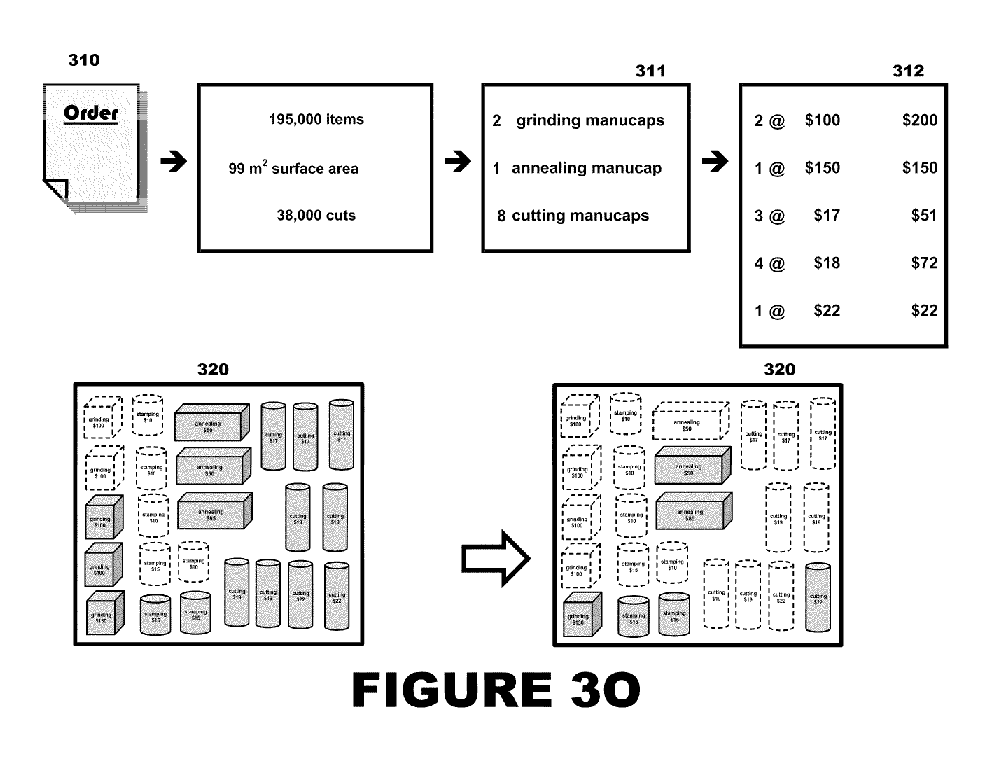

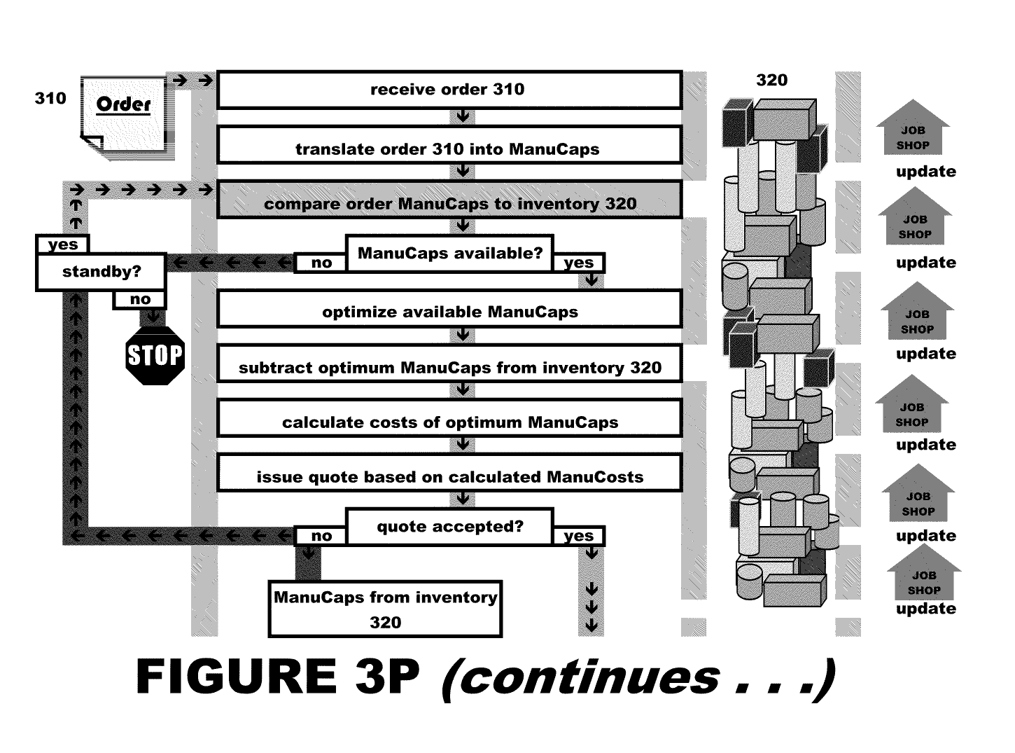

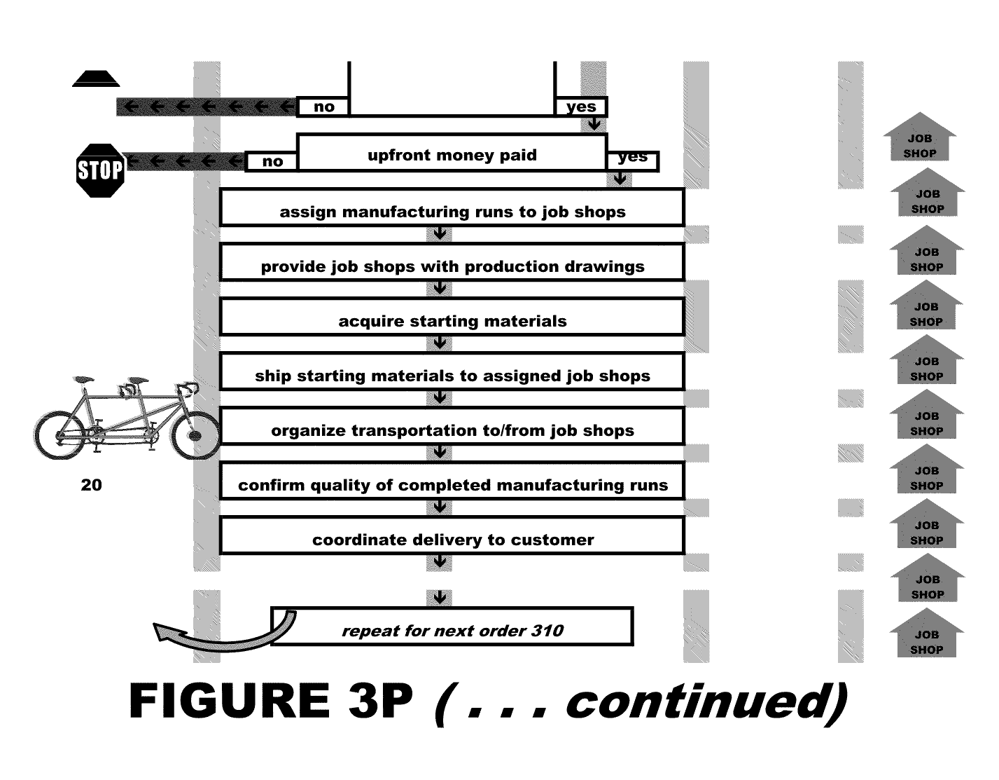

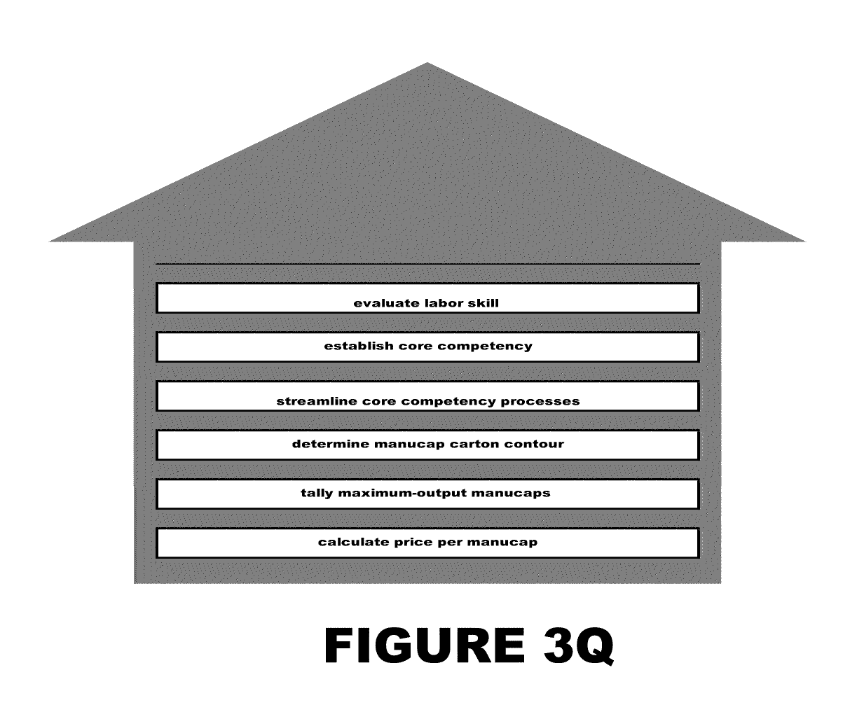

A method 300 for manufacturing articles 20 is shown in FIG. 3A. The method 300 comprises the step 320 of receiving an order 301 from a customer and the step 350 of consulting a cataloged inventory 351. As is explained in more detail below, the cataloged inventory 351 comprises current manufacturing capabilities (with corresponding costs) for a plurality of job shops.

The method 300 further comprises the step 380 of appointing one or more job shops to manufacture components 18 of the articles 20. The job-shop appointment is based on the inventory-consulting step 350. Specifically, the job shops with the most optimum manufacturing capabilities available at the time are selected. The appointed job shops then manufacture the components 18 in furtherance of the article-manufacturing.

The order-receiving step 320 can be performed at the manufacility 200, particularly, for example, by the manucap administration, 260. The customer could place the order 301 in person with the concierge 220. Alternatively, the order 301 could be mailed (electronically or otherwise) to the manucap administration 260.

The job shops can be members of a job shop alliance 381 that is organized, for example, through the manufacility 200. The method 300 can operate with as one job shop, but it becomes more powerful and potent with a greater number of job shops (e.g., over a hundred shops, over a thousand shops, and/or over ten-thousand shops). The alliance 381 can be (but need not be) concentrated within a given geographic region, such as within 100 miles of each other and/or the manufacility 200.

In FIG. 3A, the order 301 comprises a typical OEM order wherein the components 18 made by the job shops are conveyed to the OEM's assembly site 19. The method 300 offers an OEM the one-stop-shopping convenience of placing all of its orders 301 at a common counter (e.g., with the concierge 220 at the manufacility 200). This approach frees OEMs from the time-consuming, document-intensive, and costly task of establishing relationships with individual job shops. The method 300 also allows job shops to transparently team together when an OEM order 301 calls for a quantity well beyond the capacity of any one single shop.

As shown in FIGS. 3B-3C, the method 300 can accommodate plural OEM orders for different articles. In fact, the method 300 may work most efficiently with multiple orders 301, in that more job shops can be appointed. Additionally or alternatively, it increases the chances of successfully ganging groupable components thereby reducing costs for the customer and/or increasing profits for the job shops.

The order 301 can comprise, as shown in FIGS. 3D-3E, a manufactured article 20 such as a traditional OEM end product (e.g., a bicycle). In this situation, the surrogate sectors 280 of the manufacility 200 can perform the necessary engineering design and/or starting-material sourcing.

And as is shown in FIG. 3F, the method 300 can accommodate both OEM and non-OEM orders 301. These orders 301 can be received simultaneously or sequentially, and they can cover related or unrelated components 18. This may be especially competitive pricing for small non-OEM orders, as they can “stand by” and wait to be grouped or ganged with larger OEM orders.

Turning now to FIG. 3G, the input-output path of a job shop is schematically shown. As was indicated above, the inventory 351 is a catalog-like index of current manufacturing capacity with corresponding costs for a plurality of job shops. In the illustrated method 300, these capabilities are conceptually measured into units 352 that can be called “manucaps.”

The manucap model of the method 300 can be patterned, to some extent, after the stock-market model used by the financial world to broker “shares” of a company. While a company cannot really be physically separated into distinct tangible blocks, this convention is nonetheless successfully used as a yardstick to embody a company's value. And these stock-market shares are bought, sold, and traded as if they were touchable boxes stacked in a warehouse.

But unlike stock-market shares, a manucap 352 is not intended to represent the financial worth of a job shop. Instead, manucaps 352 characterize and quantify a job shop's capacity to transform an input (e.g., starting materials 17) into an output (e.g., components, 18, assembly 19, articles 20). Significantly, and unlike most indexes, the actual input and/or the actual output of a job shop are not pertinent parameters. Instead, the focus is on the essentially intangible translation of the input into the output. When the job shops are not defined solely by their traditional inputs and outputs, a wider range of opportunities immediately become available to them.

By way of an example, a job shop traditionally typified as a canopy-making company can be categorized by fabric-cutting manucaps 352 and fabric-stitching manucaps 352. In this manner, when an order 301 is received for velvet tote bags, a consultation of the inventory 351 will flag this “canopy-making company” as a suitable candidate. In contrast, a conventional index would only flag this job shop for a canopy-making order.

By way of another example, a charm-bracelet-making job shop is not cataloged in the inventory 351 by jewelry manucaps. Instead, this job shop would be characterized by its aesthetic sensibility, its attention-to-elegance, and its equipment. Thus, with the method 300, this shop becomes a candidate for the manufacture of ornamental crematory urns (which often have a profit margin greatly outpacing costume jewelry).

Each manucap 352 comprises a tag 353 containing pertinent parameters, such as is shown schematically FIG. 3H. These parameters can include, for example, a job shop identification number (e.g., a nine-digit code), a core competence characterization (e.g., annealing, grinding, stamping, cutting, etc.), carton contour (e.g., surface area, items, run length, cuts, etc.), a current per-manucap price (e.g., dollars), and turn-around time (e.g., business days, hours, minutes). While this information is irrelevant (and transparent) to the customer placing the order 301, it serves an important purpose in job-shop appointment, order pricing, and delivery-date projections.

As shown in FIGS. 31-3L, each job shop has a certain number of manucaps 352 to contribute to the cataloged inventory 351. The illustrated job shops each have only one “core competency,” namely grinding (job shop 552789221), stamping (job shop 814398985), annealing (job shop 123442222), cutting (job shop 400343322) and another cutting (job shop 669912344). A job shop can have one, two, or three core competencies. (While a job shop having four or more core competencies is possible and contemplated, it is often uncharacteristic).

The term “core competency” refers to the work whereat a particular job shop does its best work, performs most efficiently, and (perhaps most importantly), can make a healthy profit while still being globally cost-competitive. In other words, it is the job shop's “sweet spot.” Significantly, core competency is not necessary tied to any particular input or output, but rather the “black box translation” therebetween.

When a job shop sticks to its core competency, it is more competitive. Specifically, for example, the job shop can participate in the economy of scale that is enjoyed by larger enterprises. They can buy deep, rather than wide, when acquiring materials. Additionally or alternatively, it can become worthwhile for them to invest in advanced manufacturing, which is usually much more profitable.

It is expected that several job shops will usually share the same core competencies. Such overlap allows the method 300 to transparently team job shops together to meet the volume requirements of a large order 301 (e.g., an OEM or government order). Thus, with the method 300, common core competencies do not create unwelcome competition, but rather almost exponentially expand market opportunities for individual job shops.

As shown in FIG. 3M, the manucaps 352 are compiled together to form the cataloged inventory 351. This compilation can be conceptually equated to a cabinet having its shelves stocked with manucaps 352. As is explained in more detail below, this cabinet can be opened to view (i.e., consult) the contents of the cataloged inventory 351. And manucaps 352 can be removed, matched, and returned to the cabinet's shelves. In the inventory-consulting step 350, an order 301 is translated into manucaps 352 and then compared to those currently available in the cataloged inventory 351.

If manucaps 352 are available to fulfill the order 301, they are optimized to provide the most efficient and economic production price and delivery. By way of example, suppose the order 301 translates into eight cutting manucaps 352 and turn-around-time is not crucial. In this case, the $17 cutting manucaps (from job shop 400343322) will be delegated first, the $19 cutting manucaps will be delegated next, and the $22 cutting manucap (from job shop 400343322) will be delegated last.

Once an order 301 has been optimized, the manucaps 352 are reserved and figuratively removed the cataloged inventory 351. As is shown in FIGS. 3M-3N, these translation, comparison, optimization, and reservation steps are repeated for each received order 301. And as is shown in FIG. 30, the method 300 allows the ganging of groupable manucaps 352 together, so as to reduce the price for all involved orders 301.

Referring back to FIG. 3L, if manucaps 352 are not available to fulfill the order 301, the customer has the option of being placed on standby. As shown in FIG. 3P, this standby status places the order 301 essentially “on hold” until the needed manucaps 352 becomes available. The inventory 351 can be equipped with triggers to notify the customer and/or the manufacility 200 when such manucaps 352 are returned to the inventory 351. It is also possible to provide an estimate of wait-time to a stand-by customer, based on the tagged turn-around-times for the relevant manucaps 352.

In a quote-issuing step 360 of the method 300, the manucap costs are calculated (from their tags 353). Other non-manucap expenses are then added thereto. These expenses can include, for example, starting materials, engineering design, and/or profit margin for the method-performing party (e.g., the manufacility 200). A delivery date can then be projected and the quote prepared.

If the quote is not accepted, the reserved manucaps 352 are returned to the cataloged inventory 351 (e.g., placed back in the cabinet), and the customer has the option of going on stand-by. The non-acceptance of a quote will often be motivated by a too-expensive price that cannot be absorbed by a small-volume customer. With the method 300, the customer can “stand by” for a large-volume order 301 (e.g., an OEM order) to hit and then gang therewith.

If the quote is accepted, a contracting step 370 can be performed. In this step, terms are agreed to, papers are signed, and payment is made or at least arranged. If any of these do not happen, the order 301 is truncated, and the reserved manucaps 352 are returned to the cataloged inventory 351. A stand-by status may be an option at this point, but a policy to the contrary is possible and contemplated. The purpose of the quote step is to flush out any issues prior to the contracting step to avoid false starts, avoiding manucaps 352 being unnecessarily “reserved” and thus unavailable.

Once the contracting step 370 is completed, the manucap-associated job shops are appointed components 18 in the step 380, and the article-manufacturing step 390. This step comprises doling out production drawings 16 and supplying starting materials 17 to the appointed job shops. The components 18 are then manufactured and are transported among the shops along the production path. The components 18 are eventually inspected, assembled into the article 20, and delivered to the final destination 30.

The production drawings 16 and/or the starting materials 17 may be provided by the OEM or a surrogate OEM (e.g., the manufacility 200). Likewise, the inspection, assembly, and delivery steps can be performed by the OEM or a surrogate OEM.

Transportation of the components 18 to and among job shops has traditionally been handled by the job shops, not the OEM. With the method 300, this transportation can be organized by the alliance 381 and/or the manufacility 200. In this manner, instead of each job shop having to arrange its own vehicle, a shared fleet can roam the alliance area for pick-ups and drop-offs. The logistics of this traffic can be coordinated through, for example, a dispatcher in the manucap administration 260 at the manufacility 200.

When a job shop 18 completes manufacturing appointed components 18, the corresponding manucaps 352 are returned to the cataloged inventory 351 and thus once again available for incoming orders 301.

Turning now to FIG. 3Q, an inventory-constructing step 330 and an inventory-updating step 340 are shown preceding the inventory-consulting step 350.

The constructing step 330 can be performed by an audit team trained in manucap appraisal (e.g., from the manucap administration 260) during an induction visit to a job shop. Such an induction visit and/or audit can be a prerequisite for participation in the method 300, and/or for membership in the alliance 380. (A procedure where job shops can submit manucap assessments without audit is possible, but an outside analysis will provide more objectivity and/or credibility.)

At each job shop, the audit team can appraise existing equipment and commissioned skill sets to establish this job shop's core competency. Once a job shop's core competency is discovered, the audit team can investigate ways to further streamline its forte. The aim of the audit is to identify each job shop's sweet spot and to make it as efficient and effective as possible therein.

The inventory-constructing step 330 can include a determination of the best “carton contour” for a particular job shop's manucaps 321. The carton's “dimensions” are preferably made as small as reasonably possible, so as to increase the potential for smaller runs without a sacrifice profitability. Small carton dimensions can also encourage repetitive business.

Thus, if single-item manufacturing runs are possible at a particular job shop, and essentially as economical as a hundred-items run, then its carton contour should correspond to a single item. On the other hand, if a single-item run costs in the same range as a hundred-items run, then the carton contour should be of a larger hundred-item size.

Often, the number of involved “items” will be the appropriate enumeration for manucap-contour computations. But sometimes other units of measure (e.g., surface area, run length, cut repetitions, etc.) may be more suitable capacity-quantifying units. The inventory-constructing step 330 can be made flexible so as to allow for the most cost-competitive combinations and opportunities.

Once core competencies are established and contours are determined, a job shop's maximum number of manucaps 352 can be tallied. This tally provides the highest possible production for the job shop, when it is operating in a full-court-press mode. Each of these manucaps 352 is provided with a tag 353 indicating the shop's identity and the carton contours.

The constructing step 330 can also comprise contriving an equation to calculate the cost of each manucap 352. The actual cost at the time of the audit can also be computed, with the understanding that this value will fluctuate over time due to the uncontrollable nature of many overhead expenses. And the equation (and thus price) can vary among identical manucaps 352 within a job shop, as certain expenses in the equation can increase/decrease depending upon volume.

The audit team can also determine turn-around times for a job shop's manucaps 352. These times can also vary among identical manucaps 352, if equipment downtime comes into play above certain volume levels.

When an audit for a job shop is completed, its maximum manucaps 352 and corresponding current-price tags 353 are compiled in the cataloged inventory 351, just as one would stack canisters in a cupboard. Once the canisters are in the cupboard, the inventory-updating step 340 may come into play.

The inventory-updating step 340 comprises removing reserved manucaps 352 from the cataloged inventory 351 (e.g., when a quote is being issued) and replacing reserved manucaps 352 (e.g., when a quote is not accepted and a customer opts to go on standby status). The step 340 also includes replacing manucaps 352 for completed components 18 and/or deducting 352 for proprietary work. A job shop's maximum manucaps 352 can also change due to, for example, equipment maintenance.

The inventory-updating step 340 also comprises revising manucaps tags 353 to reflect current conditions. For example, manucap price can be independent of starting-material costs, but overhead expenses (e.g., fuel prices, maintenance fees, employee wages, etc.) must usually be injected into this calculus. Thus, the per-manucap price can, and will, change as these essentially uncontrollable expenditures fluctuate. And price can vary among manucaps 352, if output above or below a certain volume increases expenses due to overtime pay, peak-time energy usage, or other factors.

For these reasons, and as indicated above, the audit team preferably devises an equation for the cost-per-manucap parameter. With this procedure, a job shop does not need to calculate costs on a daily basis, but rather just record overhead expenses. And many of these expenses are dictated by outside influences (e.g., fuel costs, weather changes, etc.) that can be automatically gathered without a specific contribution from the job shops.

The inventory-updating step 340 can be preferably performed electronically whereby job shops need only submit a brief daily report of relevant data. If a report is not submitted, a reminder can be issued by, for example, the manucap administration 260 of the manufacility 200. In this same regard, a traveling band of manucap-administration experts can periodically visit job shops to assist and encourage the updating step 340. This latter task would be an excellent assignment for young engineering students.

As was indicated above, the inventory-constructing step 330 can precede the inventory-consulting step 350. During the infant stages of the method 300, this will be true, as a cataloged inventory 351 must be compiled prior to the consulting step 350. However, as things progress, audits can be ongoing steps as further job shops are infused into the alliance 381. And in certain stages, the inventory-constructing step 330 will overlap and/or resemble the inventory-updating step 340.

Thus the method 300 creates a system wherein job shops can do what they do best. More specifically, it allows job shops to manufacture component parts 18 (and prosper), and thereby allows industrial regions to economically recover (and thrive).

### Method 400

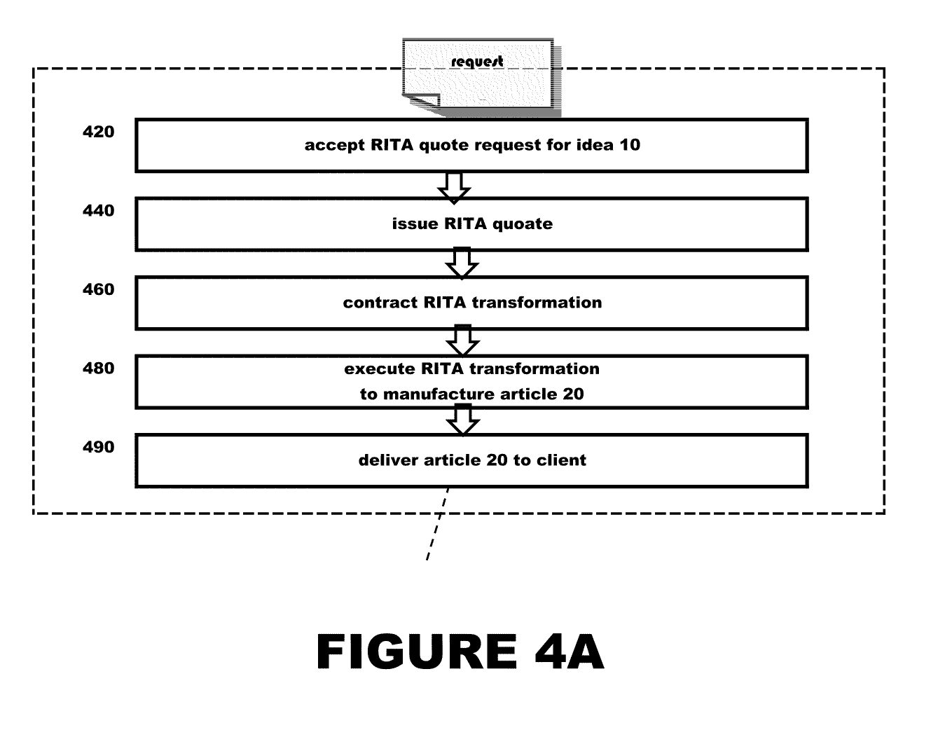

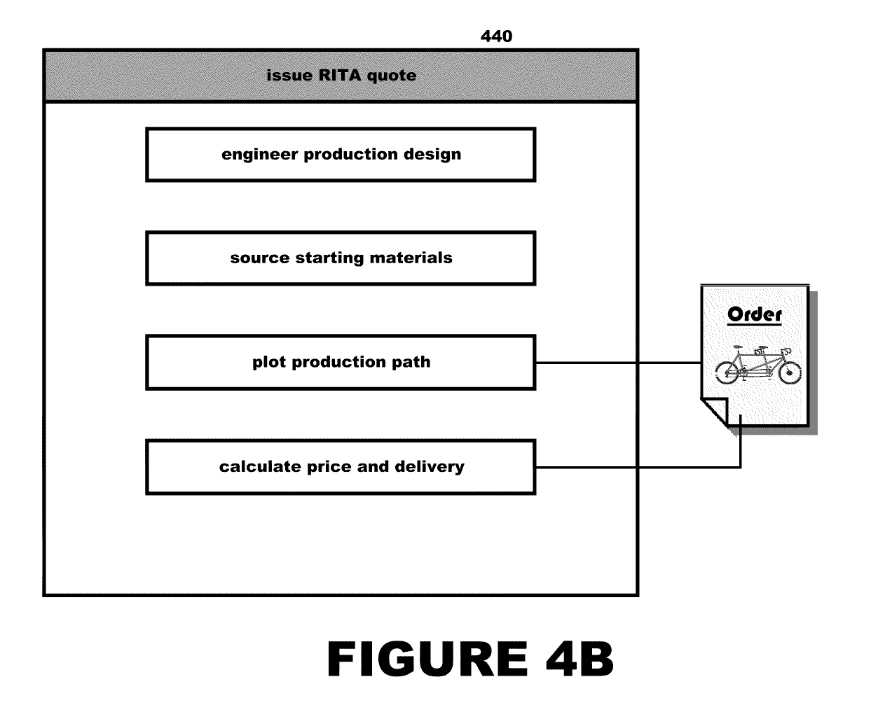

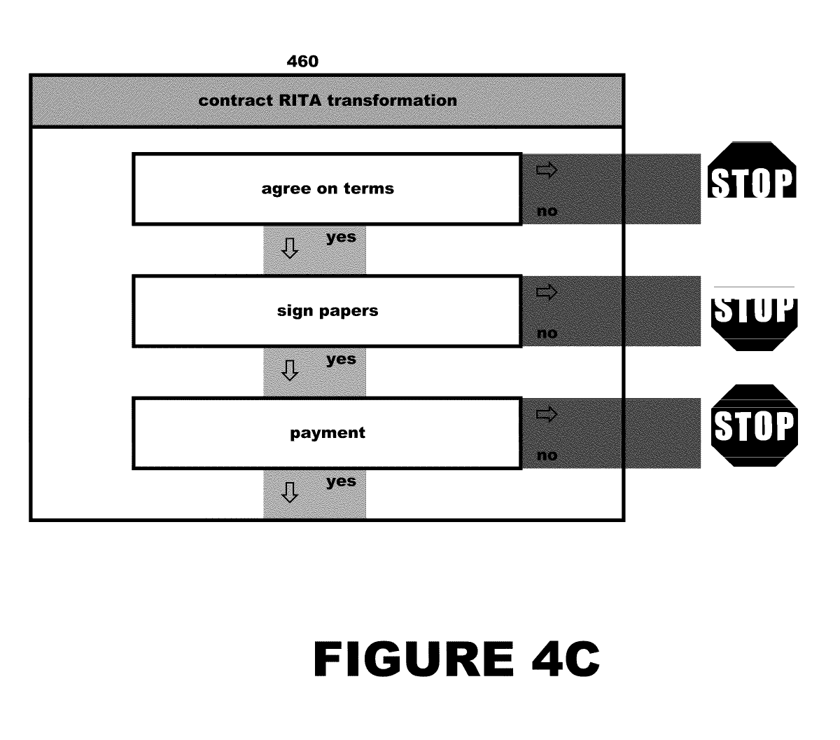

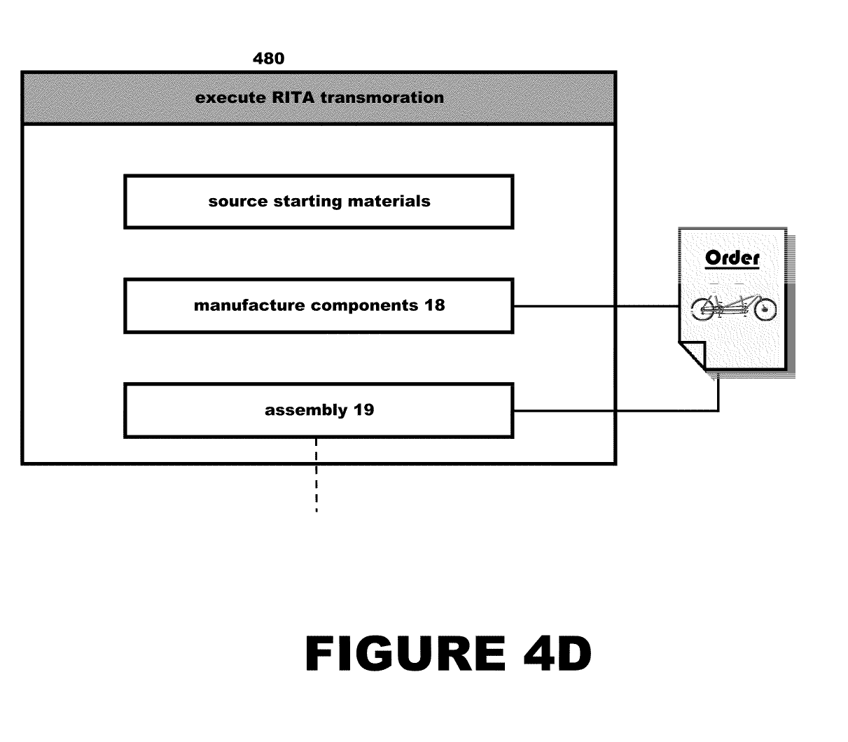

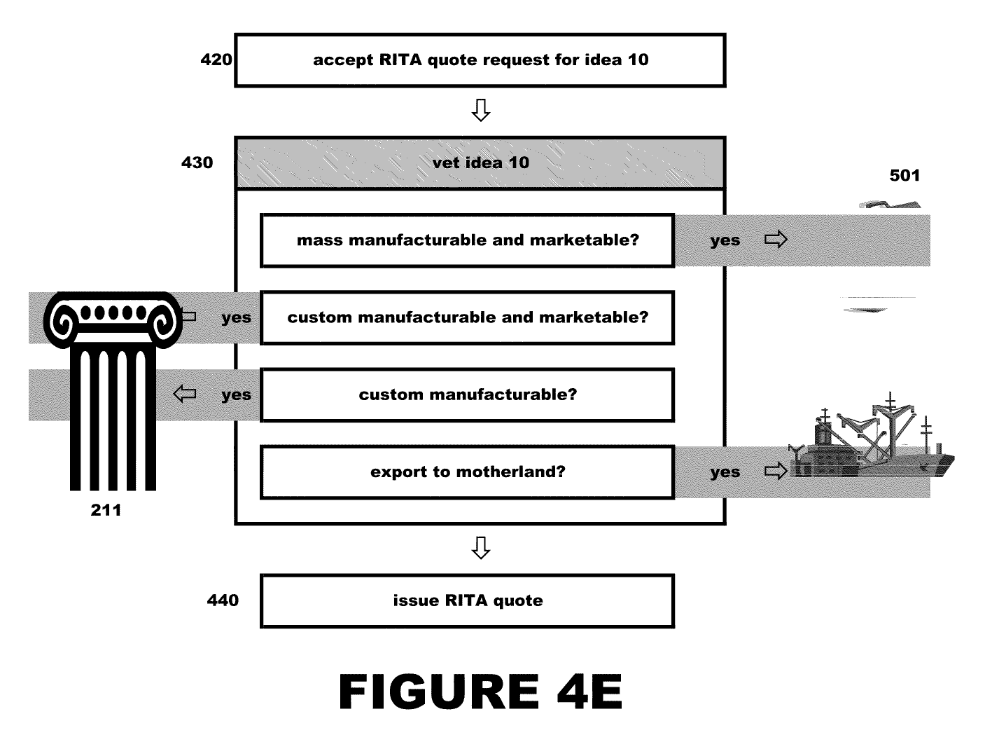

A method 400 for manufacturing an article 20 is shown in FIG. 4A. The method 400 comprises steps adapted to perform a RITA (raw-idea-to-article) transformation. More specifically, the method 400 comprises the step 420 of accepting a RITA quote request 401 for an idea 10, the step 440 of issuing a RITA quote, and the step 460 of contracting for the RITA transformation. Once the contracting step 460 is completed, the RITA transformation is executed and article 20 is manufactured (step 480). And then the article 20 is delivered to the client (step 490).

The request-accepting step 420 can be performed at the manufacility 200. The client could, for example, place the request 401 at the concierge 220 and the concierge could refer him/her to the appropriate quoting department. Significantly, the request 401 does not require anything more than the raw idea 10 and perhaps a sketch thereof.

The quote-issuing step 440, shown in FIG. 4B, comprises formulating a RITA transformation strategy (e.g., engineering a production design, sourcing starting materials, plotting a production path, etc.) and calculating price and delivery date for this transformation. These activities can be performed, for example, by the surrogate sectors 280 of the manufacility 200. The production path and price/delivery calculations can be achieved by submitting a corresponding order 301 into the method 300 discussed above.

The contracting step 460, shown in FIG. 4C, comprises agreeing on terms, signing papers, and accepting payment. Thereafter, as shown in FIG. 4D, the RITA transformation strategy is executed by, for example, acquiring starting materials 17, manufacturing components 18, and assembly 19. The starting materials can be acquired, for example, by the surrogate sectors 280 of the manufacility 200. The components 18 and the assembly 19 can be achieved by acceptance of the order 301 in the method 300.

A manufactured article 20 can stem from an idea 10 that is nothing more than a conceptual sketch. A really good “raw” idea indeed requires a certain type of intellect, if not a flash of genius. But the more difficult part is usually the subsequent struggle to transform this raw idea into an article of manufacture. As was explained above, sketch-to-shelf conversions (and thus raw-idea-to-article transformations) occur traditionally in the land of OEMs. Even those with abundant financial resources can find it difficult, if not impossible, to accomplish the raw-idea-to-article (RITA) transformation.

With the method 400, a RITA transformation is possible for anyone with an idea 10, and the means to pay to manufacture a corresponding article 20. But the method 400 provides much more than a toy-building playground for the wealthy. It serves as a crystal-ball-like window into customer wants and needs.

As was explained above, in the traditional OEM scheme, an idea 10 is born without any direct customer input. The RITA transformation method 400 not only injects customer input into the process, but it does so at the very beginning of the game. The RITA transformation method 400 short-circuits the survey-redesign steps in a conventional OEM sketch-to-shelf conversion. Customers' needs and wants are hand-delivered on a silver platter without having to depend upon OEMs to research and develop such dreams.

If a grandparent client wishes to create a new toy for a grandchild, for example, chances are good that this child would not be the only happy recipient of such a toy. If a homeowner client wants an easier way to clean gutters, odds are that scores of other homeowners are experiencing similar gutter-cleaning problems. And/or if an athletic client insists on a better means to carry keys while jogging, there is a strong probability that other runners would prefer the same.

With particular reference to new Americans, they perhaps understand the needs and wants of the people in their motherlands better than anyone else. This intimate knowledge results in their ideas 10 hitting the target much more accurately when products are aimed at the export market. And if family and friends overseas would enjoy and appreciate articles 20 transformed from such clients' ideas 10, the rest of the country probably would want more of the same.

The RITA method 400 eliminates the need for seasoned (and expensive) professionals to spend time getting into the mindset of desired customers. This inner knowledge, which is fundamental to the success of any product, is provided free of charge by the RITA-method client. As was indicated above, it is delivered on a silver platter at the manufacility 200.

### Method 500

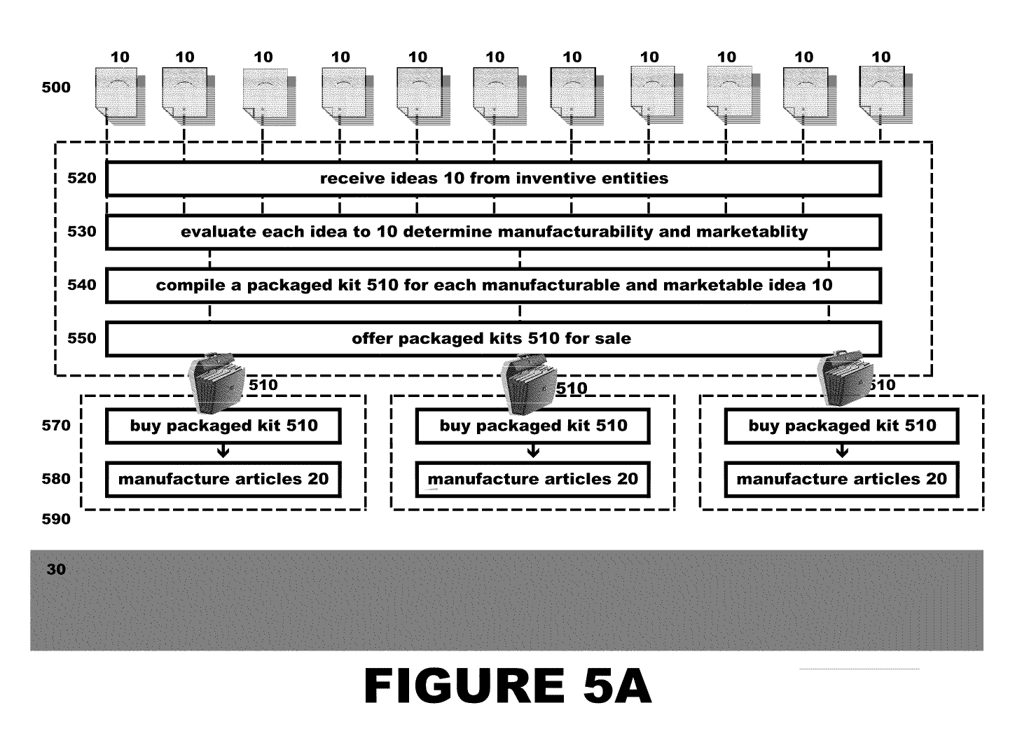

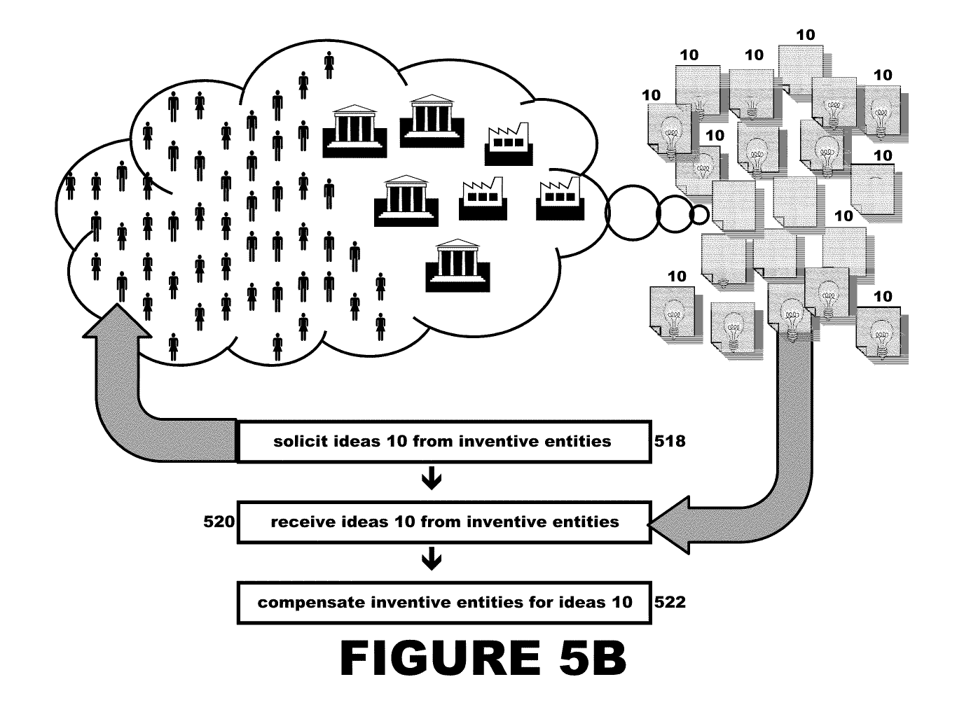

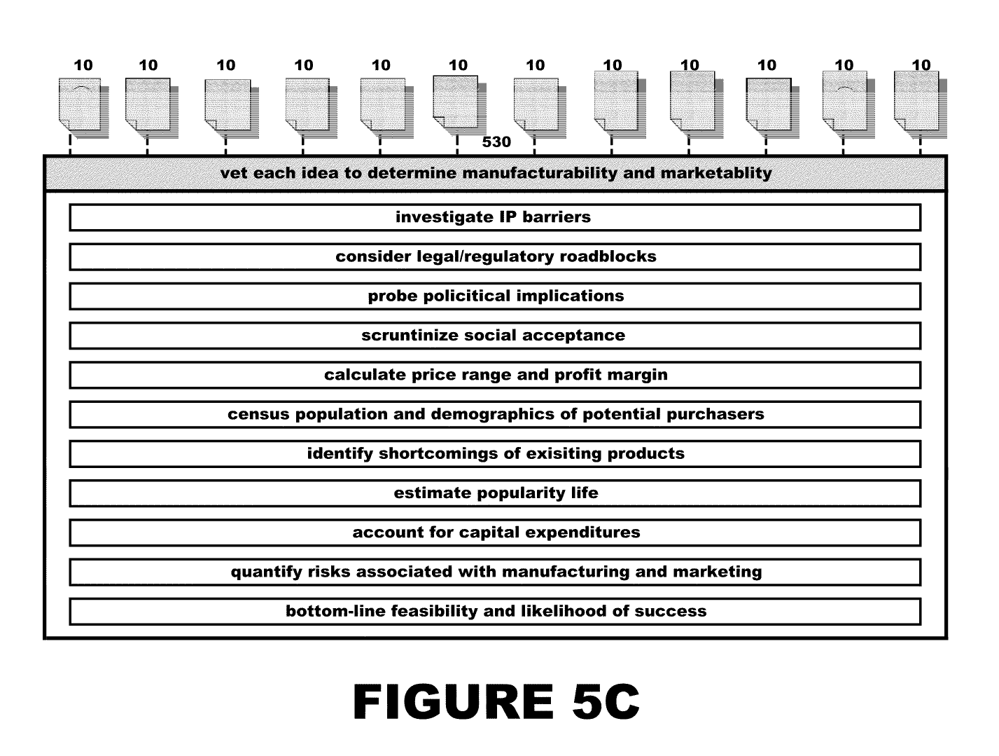

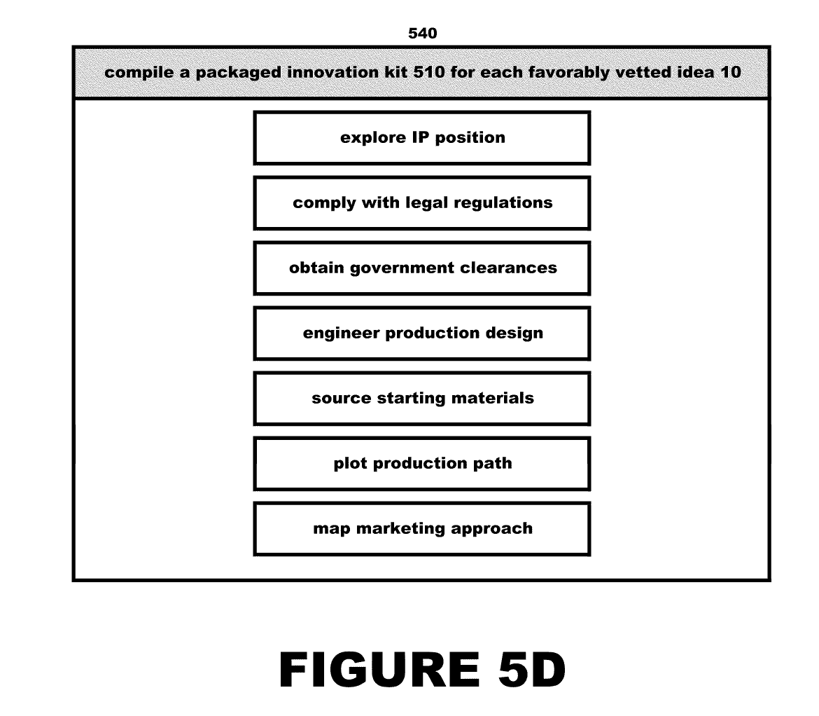

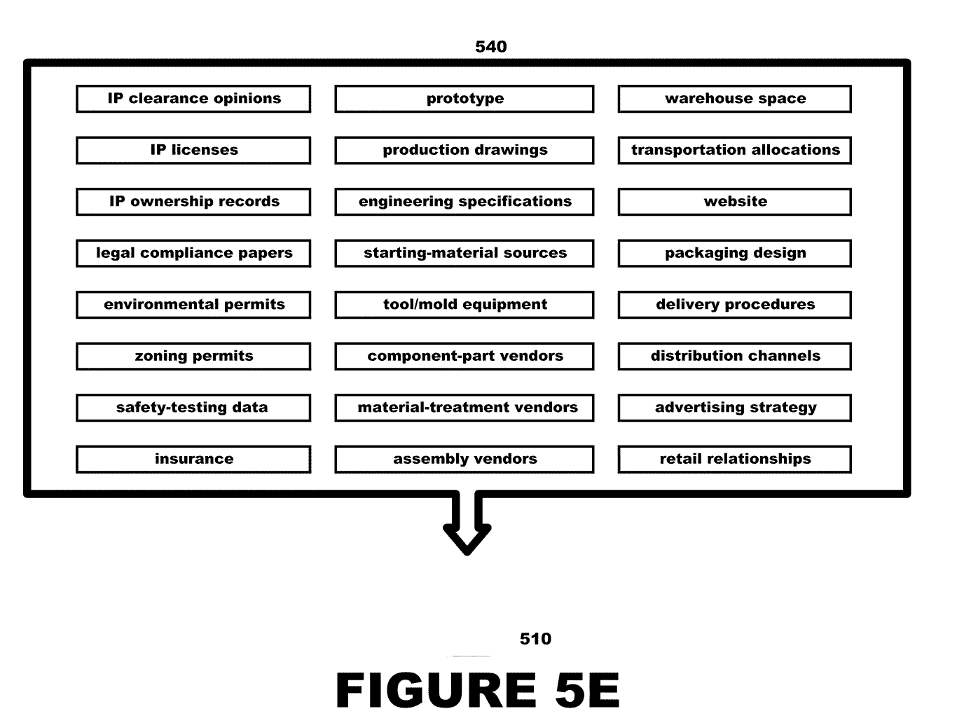

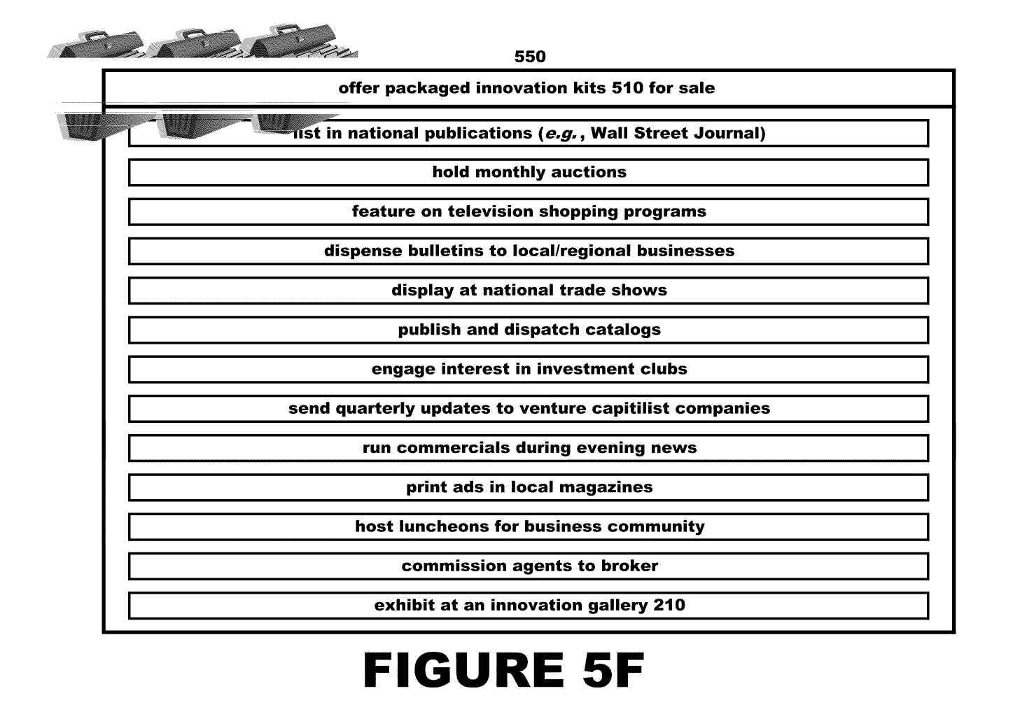

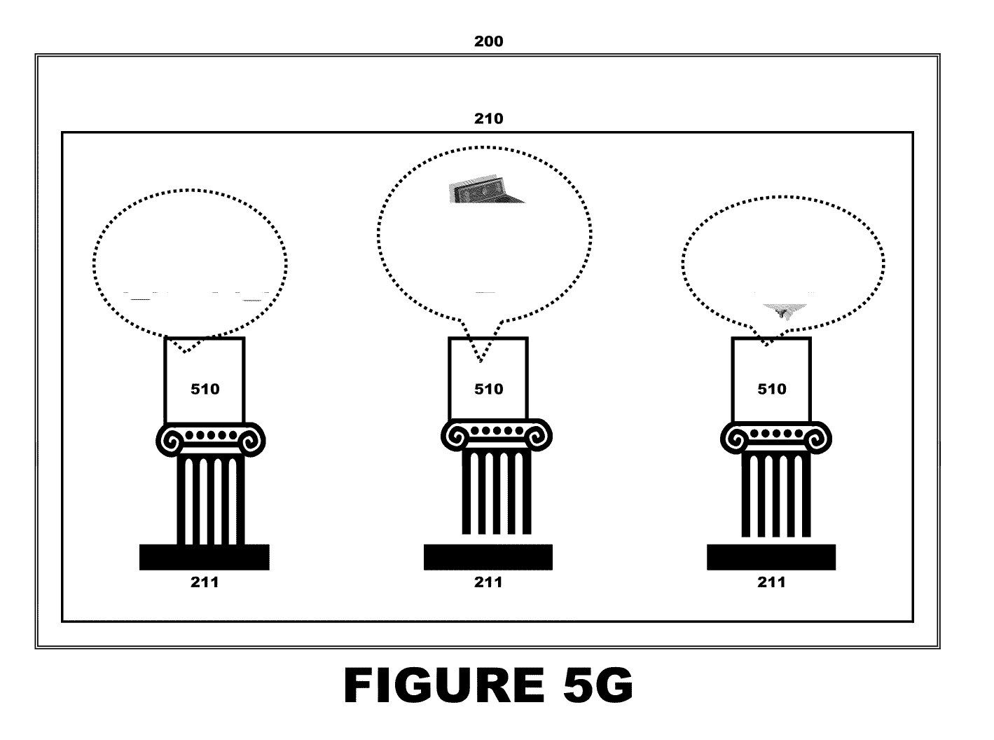

A method 500 for manufacturing articles 20 is shown in FIG. 5A. In the method 500, ideas 10 are obtained from inventive entities (step 520). These ideas 10 are then vetted to determine their marketability (step 530) by the method-performing party (e.g., the manufacility 200). A packaged innovation kit 501 is compiled for each favorably vetted idea 10 (step 540) and then offered for sale (step 550). Upon purchase of a packaged innovation kit 501 (step 580), a startup business can be launched and the articles 20 manufactured (step 590). The articles 20 can thereby be commercially carried to their final destination 30 to benefit the economy.

The method 500 recognizes that a startup business is sometimes the best vehicle for converting a really good idea 10 into an article of manufacture 20. The method 500 also appreciates that while good ideas generally originate with creative inventors, these inventors are often not entrepreneurs. In the past, the approach has been to incubate inventors into a business that will somehow magically turn them into sales-savvy entrepreneurs. Needless to say, this has not worked, because inventors want to be inventors, not business owners.

The approach of the method 500 is to incubate ideas (not inventors) and efficiently place these incubated ideas in the entrepreneurial hands capable of bringing them to fruition. No drastic personality changes are necessary. Inventors get to be inventors (and safely contribute their ideas 10) and entrepreneurs get to be entrepreneurs because now they have a product to sell.

The idea-obtaining step 520 and the offering step 550 can be preferably performed at the same location. The idea-vetting step 530 and/or the kit-compiling step 540 can also be performed, or at least coordinated, from this location. For example, the idea-obtaining step 520 can be done with the manufacility concierge 220 and the offering step 550 can include showcasing the innovation kit 501 in the manufacility gallery 210. The surrogate sectors 280 and/or the manucap administration 260 can contribute to the idea-vetting and/or kit-compiling steps.

The idea-obtaining step 520 is shown in FIG. 5B. In many cases, the inventive entities are individual inventors. But they can also include educational organizations (e.g., colleges and universities), research institutes, and/or think-tank outfits.

The idea-obtaining step 520 can be preceded by a solicitation step 510 whereat ideas 10 are solicited from inventive entities. Such soliciting can accomplished, for example, through newspapers, technical publications, professional associations, and internet websites. Additionally of alternatively, publications of patent applications can be scanned weekly for suitable candidates so that they can be contacted about the corresponding inventions.

The method can additionally comprise a compensation step 530 whereat the inventive entity is compensated, in some manner, for submission of an idea (step 522). Compensation can be, for example, payment of a negotiated amount upon receipt of an idea 10, upon favorable vetting of an idea 10, upon compilation of the kit 501, and/or upon sale of the kit 501. Additionally or alternatively, compensation can comprise payment of a negotiated percentage of the kit's purchase price and/or royalties from the articles 20. The inventive entity can continue to own the idea 10 until choosing to do otherwise.

The compensating step 530 allows inventors (especially individual inventors) to profit from their ideas so that they can, in turn, spend more time doing what they are good at—inventing. And perhaps more importantly, the method 500 provides individual inventors with a forum to showcase their ideas, instead of them collecting dust in garage workshops. And the method 500 propels inventions into the marketplace where they contribute positively to the economy. Moreover, few things give an inventor more pride (and/or incentive) than seeing a personal idea mature into a globally marketed product.

While the method 500 stands to benefit individual inventors most profoundly, it also builds a gateway to capitalize on the brain power of other inventive entities such as educational organizations (e.g., colleges and universities), research institutes, and/or think-tank outfits. These groups often want their inventions conveyed into commercialism, but do not have the networks or industrial facilities to do so. And they, too, would enjoy the same financial and notoriety rewards that come with having an invention brought to life on store shelves.

Referring now to FIG. 5C, the vetting step 540 is shown. This step 540 can comprise, for example, investigating IP barriers (e.g., dominating patents, unlicensable copyrights, etc.), considering legal/regulatory roadblocks (zoning, environmental restrictions, etc.), probing political implications (e.g., local/state objections, elected-official changes, etc.), and scrutinizing social acceptance (e.g., liberal, conservative, etc.). The vetting can include calculating prices/profits, censoring population and demographics, identifying shortcomings of existing products, and estimating how long it will remain popular life. Capital expenditures can be accounted for in this step, along with risks being quantified. The idea-vetting step 540 jumps through whatever hoops are necessary to bottom-line feasibility and likelihood of success. In other words, it separates the good from the bad, the pretty from the ugly, and the winners from the losers.

If an idea 10 passes muster in the vetting step 540, it moves onto the compiling step 550 shown in FIG. 5D. The kit-compiling step 550 can comprise exploring intellectual property positions, complying with legal regulations, obtaining government clearances, engineering the production design, sourcing starting materials, plotting the production path, and mapping the marketing strategy. The kit-compiling step 550 can be performed, for example, by the surrogate sectors 280 of the manufacility 200. With particular reference to the production path, it can be plotted by submitting an order 301 to the method 300.

The packaged innovation kit 501 is shown in FIG. 5E. It can incorporate a summary of the conclusions reached during the vetting step 540. Accordingly, if venture capital is part of the picture, the packaged kit 501 can provide potential investors with an objective assessment of feasibility, an impartial evaluation of commercial impact, an independent research record regarding risks, and/or a neutral narrative on financial figures. The kit 501 can contain transportation arrangements, a ready-to-go website, fabricated packaging, delivery procedures, distribution channels, an advertising/marketing strategy, and retail relationships.

The value of the vetting step 540 and the kit-compiling step 550 to an entrepreneur are priceless. With the method 500, an energetic entrepreneur can shop for the quintessential product, purchase the corresponding packaged kit 501, and then hit the ground running. The entrepreneur does not have to worry about matters outside his/her entrepreneurial skill set, and instead can fully focus on getting the business going.

The offering step 560 can comprise whatever means and methods are necessary to capture of the interest of promising entrepreneurs. This step 560 can comprise listings in national publications (e.g. Wall Street Journal), holding periodic auctions, features on television shopping programs, bulletins, trade shows, catalogs, investment-club pitches, prime-news-time commercials, magazine ads, brokers, and/or sponsoring business events. And as indicated above, and shown in FIG. 5G, the offering step can preferably comprise exhibiting a plurality of the packaged innovation kits 501 in a gallery, such as the manufacility gallery 210.

The method 500 encourages inventors to be inventors (and profitable), entrepreneurs to be entrepreneurs (and successful), job shops to manufacture component parts (and prosper), and industrial regions to economically recover (and thrive).

### CLOSING

One may now appreciate that manufacility 200 and the manufacturing methods can revolutionize and revive the American manufacturing industry. And they encourage inventors to be inventors (and profitable), entrepreneurs to be entrepreneurs (and successful), job shops to manufacture parts (and prosper), and industrial regions to economically recover (and thrive). Although the manufacility 200, the method 300, the method 400, and/or the method 500 have been shown and described with respect to a certain embodiment or embodiments, it is obvious that equivalent alterations and modifications will occur to others skilled in the art upon the reading and understanding of this specification and the annexed drawings.

1. A method (300) of manufacturing articles (20), comprising an order-receiving step (320), an inventory-consulting step (350), and a job-shop-appointing step (380); wherein:
the order-receiving step (320) comprises receiving an order (301) to manufacture at least one component (18);
the inventory-consulting step (350) comprising consulting an internal cataloged inventory (351) of current manufacturing capabilities with corresponding costs of a plurality of job shops; and
the job-shop-appointing step (380) comprising appointing, based on the inventory-consulting step (350), the most capable and cost-competitive job shop(s) to manufacture the components (18);
wherein the job shop(s) manufacture the components (18) and thereby contribute to the manufacture of the articles (20).

2. A method (300) as set forth in claim 1, wherein said order-receiving step (320) comprises receiving multiple orders (301) to manufacture several different articles (20), these orders (301) being received simultaneously and/or sequentially.

3. A method (300) as set forth in claim 2, wherein at least some of the orders (301) are received from non-OEM submitters.

4. A method (300) as set forth in claim 2, wherein at least some of the orders (301) are received from traditional OEMs.

5. A method (300) as set forth in claim 1, wherein said inventory-consulting step (350) and said job-shop-appointing step (380) comprises:
translating each order (301) into manucaps (352);
comparing these manucaps (352) to those currently available in the cataloged inventory (351); and
optimizing manucaps (352) to provide the most efficient and economic production price and delivery.

6. A method (300) as set forth in claim 1, wherein each manucap (352) comprises a tag (353) containing pertinent parameters including a job shop identification, a core competence characterization, capacity contours, and turn-around-time estimates.

7. A method (300) as set forth in claim 6, wherein said manucap-optimizing step comprises ganging of groupable manucaps (352) together so as to reduce the price for all involved orders (301).

8. A method (300) as set forth in claim 1, wherein said inventory-consulting step (350) and said job-shop-appointing step (380) further comprises placing a customer on standby if manucaps (352) are not currently available to fulfill the respective order (301).

9. A method (300) as set forth in claim 8, wherein said inventory-consulting step (350) and said job-shop-appointing step (380) further comprises the step of notifying the customer when manucaps (352) become available to fulfill the respective order (301).

10. A method (300) as set forth in claim 1, wherein the cataloged inventory (351) is based on auditing appraisals of job shops' existing equipment and commissioned skill set.

11. A method (300) as set forth in claim 1, wherein the job shops are members of an alliance (381) concentrated within a given geographic region.

12. A method (300) as set forth in claim 1, wherein said order-receiving step (320), said inventory-consulting step (350), and/or said job-shop-appointing step (380) are performed in a manufacility (200) comprising a gallery (210), concierge (220), a networking lounge (230), a training center (240), a media room (25), a manucap administration (260), a customer service group (270), surrogate sectors (280), and job shop advocates (290).

13. A method (400) for manufacturing an article (20), said method comprising a quote-request-accepting step (430), a quote-issuing step (440), a contracting step (450), and a transformation step (480); wherein:
the request-accepting step (430) comprises accepting a request from a client to transform a raw idea (10) into the article (20);
the quote-issuing step (440) comprises formulating a strategy to transform the raw idea (10) into the article (20) and setting a price for this transformation;
the contracting step (450) comprises contracting with the client to buy the article (20) at the set price; and
the transformation step (480) comprises executing the formulated strategy to manufacture the article (20).

14. A method (400) as set forth in claim 13, wherein said quote-issuing step (440) comprises engineering a production design, sourcing starting materials, plotting a production path, and/or calculating price for manufacture of the article.

15. A method (400) as set forth in claim 13, wherein said transformation step (480) comprises acquiring starting materials (17), manufacturing components (18), and assembly (19).

16. A method (300) as set forth in claim 13, wherein said request-accepting step (430), said quote-issuing step (440), and/or said contracting step (450) are performed in a manufacility (200) comprising a gallery (210), concierge (220), a networking lounge (230), a training center (240), a media room (25), a manucap administration (260), a customer service group (270), surrogate sectors (280), and job shop advocates (290).

17. A method (500) for manufacturing articles (20), comprising an idea-obtaining step (520), an idea-vetting step (530), a kit-compiling step (540) and an offering step (550); wherein:
the idea-obtaining step (520) comprises obtaining ideas (10) from inventive entities;
the idea-vetting step (530) comprises vetting each idea (10) to determine its manufacturability and marketability;
the kit-compiling step (540) comprises compiling a packaged innovation kit (501) for a favorably vetted idea; and
the offering step (550) comprises offering the packaged innovation kit (501) for sale whereby it may be purchased, a startup business launched and the articles (20) manufactured.

18. A method (500) as set forth in claim 17, wherein the inventive entities are individual inventors, educational organizations, research institutes, and/or think-tank outfits.

19. A method (500) as set forth in claim 17, further comprising a compensation step (530) whereat the inventive entity is compensated for submission of an idea (10).

20. A method (500) as set forth in claim 17, further comprising a solicitation step (510) whereat ideas (10) are solicited from the inventive entities.
